(19) United States
(12) Patent Application Publication
(10) Pub. No.: US 2024/0345806 A1
(43) Pub. Date: Oct. 17, 2024

(54) COMPUTING APPARATUS AND METHOD, ELECTRONIC DEVICE AND STORAGE MEDIUM

(71) Applicants: Beijing Youzhuju Network Technology Co., Ltd., Beijing (CN); Lemon Inc., Grand Cayman (KY)

(72) Inventors: Zhitao Yang, Beijing (CN); Qi Chen, Beijing (CN); Jian Lai, Beijing (CN); Yimin Chen, Los Angeles, CA (US); Shan Lu, Los Angeles, CA (US); Jian Wang, Beijing (CN)

(21) Appl. No.: 18/630,753

(22) Filed: Apr. 9, 2024

(30) Foreign Application Priority Data
Apr. 11, 2023 (CN) 202310382667.1

(51) Int. Cl. G06F 7/544; G06F 7/487

(52) U.S. Cl. CPC G06F 7/5443; G06F 7/4876

(57) ABSTRACT

A computing apparatus and method, an electronic device and a storage medium are provided. The computing apparatus includes: a preprocessing module configured to receive N pairs of input parameters, and perform format conversion on each pair of input parameters according to the precision type of the N pairs of input parameters, and obtain N pairs of processed input parameters; and a calculation module configured to respectively compute a product of exponents and mantissas of each pair of processed input parameters, and obtain an output result based on the product of exponents and mantissas of each pair of processed input parameters. The computing apparatus supports multiply-accumulate computation of a plurality of floating-point types. The computing apparatus can multiplex the multiplication computation of the mantissa and make the computing apparatus support multiply-accumulate computations in a plurality of precision formats at the cost of lower area and power consumption.

### CROSS-REFERENCE TO RELATED APPLICATION

The present disclosure claims priority of the Chinese Patent Application No. 202310382667.1, filed on Apr. 11, 2023, the entire disclosure of which is incorporated herein by reference as part of the present disclosure.

### TECHNICAL FIELD

Embodiments of the present disclosure relate to a computing apparatus, a computing method, an electronic device, and a non-transient computer-readable storage medium.

### BACKGROUND

With the development of artificial intelligence and machine learning, new requirements are placed on numerous parallel processor devices represented by the parallel processor (e.g., a multi-core processor, a digital signal processor, etc.). The computing operation of the parallel processor may include general matrix multiplication (GEMM) or convolutional multiplication calculation. For example, in neural network processing often used in artificial intelligence and other fields, for example, the convolutional neural network often needs to perform matrix multiply and accumulation (MACC) computation, which includes multiplying the elements of two matrices at corresponding positions, and then accumulating the results of the multiplications to obtain a computation result.

### SUMMARY

This content is provided to introduce concepts in a brief form, which will be described in detail later in the Detailed Description. This content section is not intended to identify key features or essential features of the claimed technical solution, nor is it intended to limit the scope of the claimed technical solution.

At least one embodiment of the present disclosure provides a computing apparatus. The computing apparatus includes: a preprocessing module, configured to: receive N pairs of input parameters, wherein each pair of input parameters comprises two input parameters, the N pairs of input parameters have a same precision type, and N is a positive integer; and perform format conversion on each pair of input parameters according to the precision type of the N pairs of input parameters, and obtain N pairs of processed input parameters after the format conversion, wherein, in a process of the format conversion, for each input parameter whose precision type is a first floating-point type, expanding a number of significant bits in a mantissa of the input parameter to a first value, and adding exponent information of the input parameter to the mantissa of the input parameter to obtain a processed input parameter corresponding to the input parameter, wherein the number of significant bits in the mantissa of the input parameter of the first floating-point type is less than or equal to the first value; and a calculation module, configured to: respectively compute a product of exponent portions and mantissas of each pair of processed input parameters and a product of mantissa of each pair of processed input parameters, and obtain an output result based on the product of exponent portions and the product of mantissas of each pair of processed input parameters, wherein the output result is an accumulated sum of N product results corresponding to the N pairs of input parameters one by one, wherein the computing apparatus supports multiply-accumulate computation of a plurality of floating-point types.

At least one embodiment of the present disclosure provides a computing method. The computing method includes: receiving N pairs of input parameters, wherein each pair of input parameters comprises two input parameters, the N pairs of input parameters have a same precision type, and N is a positive integer, performing format conversion on each pair of input parameters according to the precision type of the N pairs of input parameters, and obtaining N pairs of processed input parameters after the format conversion, wherein in a process of the format conversion, for each input parameter whose precision type is a first floating-point type, expanding a number of significant bits in a mantissa of the input parameter to a first value, and adding exponent information of the input parameter to the mantissa of the input parameter to obtain a processed input parameter corresponding to the input parameter, wherein the number of significant bits in the mantissa of the input parameter of the first floating-point type is less than or equal to the first value; and respectively computing a product of exponent of each pair of processed input parameters and a product of the mantissa of each pair of processed input parameters, and obtaining an output result based on the product of the exponent and the product of the mantissa of each pair of processed input parameters, wherein the output result is an accumulated sum of N product results corresponding to the N pairs of input parameters one by one.

At least one embodiment of the present disclosure provides an electronic device, and the electronic device includes the computing apparatus according to any embodiment of the present disclosure.

At least one embodiment of the present disclosure provides an electronic device, and the electronic device includes a memory, non-transiently storing computer executable instructions; a processor, configured to run the computer-executable instructions, wherein the computer executable instructions implement the computing method according to any embodiment of the present disclosure upon being run by the processor.

At least one embodiment of the present disclosure provides a non-transitory computer-readable storage medium, wherein the non-transitory computer-readable storage medium stores computer-executable instructions, the computer-executable instructions upon being executed by a processor implement the computing method according to any embodiment of the present disclosure.

### BRIEF DESCRIPTION OF DRAWINGS

In order to more clearly explain the technical scheme of the embodiment of the present disclosure, the drawings of the embodiment will be briefly introduced below. Obviously, the drawings in the following description only relate to some embodiments of the present disclosure, and are not limited to the present disclosure.

FIG. 1 is a schematic block diagram of a computing apparatus provided by at least one embodiment of the present disclosure;

FIG. 2A is a schematic diagram of a process of format conversion provided by an embodiment of the present disclosure;

FIG. 2B is a schematic diagram of a process of format conversion provided by another embodiment of the present disclosure;

FIG. 3 is a structural diagram of an exponent computing unit provided by at least one embodiment of the present disclosure;

FIG. 4 is a schematic block diagram of a first level unit provided by at least one embodiment of the present disclosure;

FIG. 5A is a schematic block diagram of a first multiplication unit provided in at least one embodiment of the present disclosure;

FIG. 5B is a schematic structural diagram of a second multiplication unit provided by at least one embodiment of the present disclosure;

FIG. 6 is a schematic diagram of a compression process of a second level unit provided by at least one embodiment of the present disclosure;

FIG. 7 is a schematic flowchart of a computing method provided by at least one embodiment of the present disclosure;

FIG. 8 is a schematic block diagram of an electronic device provided by at least one embodiment of the present disclosure;

FIG. 9 is a schematic block diagram of another electronic device provided by at least one embodiment of the present disclosure; and

FIG. 10 is a schematic diagram of a non-transient computer-readable storage medium provided by at least one embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, “coupled”, etc., are not intended to define a physical connection or mechanical connection, but may include an electrical connection, directly or indirectly, that is, “connect” may include “directly connect” or “indirectly connect”. “On,” “under,” “right,” “left” and the like are only used to indicate relative position relationship, and when the position of the object which is described is changed, the relative position relationship may be changed accordingly.

Floating-point (FP) is mainly used to represent a decimal, and usually consists of three parts, namely, the sign bit, the exponent and the mantissa. For example, a floating-point number V can usually be expressed in the following form:

$$V = {( - 1 )}^{s} \times M \times {2}^{E}$$

The sign bit “s” may be 1 bit, which determines whether the floating-point number V is negative or positive; “M” denotes the mantissa, the mantissa may include a plurality of bits, which is in the form of a binary decimal and defines the precision of the floating-point; and “E” denotes the exponent, which is used to weight the floating-point, reflecting the position of the decimal point in the floating-point number V, and defining a range of values for the floating-point number V.

For example, conventional floating-point number typically includes three formats, namely, half-precision floating-point (FP16), single-precision floating-point (FP32), and double-precision floating-point (FP64), which have different numbers of bits in the exponent and mantissa.

The Al accelerator and the like have been widely used for deep learning model training. For the common convolutional operation in the deep learning model, the hardware and software are designed with special optimizations to accelerate the computing, for example, some Al accelerator vendors provide special data processing apparatus to optimize the computing. For example, DLA (Deep Learning Accelerator) is used to provide hardware acceleration for the convolutional neural network; NVDLA adopts a convolution pipeline in the convolution core engine to efficiently support parallel direct convolution operations.

For example, a data processing apparatus, such as a DLA, supports a variety of computational processing, such as a conventional numerical calculation, matrix multiplication, convolution multiplication, and the like. Moreover, the data processing apparatus is optimized for the field of artificial intelligence/deep learning and develops a variety of floating-point number formats, such as BF16 (brain floating point 16, with a bit-width of 16 bits), TF32 (Tensor Float 32, with a bit-width of 19 bits), and the like. These data formats can significantly minimize the computing resources and power consumption required for computational processing, especially the matrix multiplication or the convolutional multiplication calculation. In addition, the data processing apparatus also supports some conventional floating-point types, such as half-precision floating-point (FP16, with a bit-width of 16 bits) or double-precision floating-points (FP64, with a bit-width of 64 bits).

Table 1 illustrates the data formats of several floating-point types.

TABLE 1
Data format

| | Total | | | | Number of |
|---|---|---|---|---|---|
| Data | Number | Sign | | | Significant Bits |
| Format | of Bits | Bit | Exponent | Mantissa | of Mantissa |
| FP32 | 32 | 1 | 8 | 23 | 24 |
| FP16 | 16 | 1 | 5 | 10 | 11 |
| BF16 | 16 | 1 | 8 | 7 | 8 |

As illustrated in Table 1, for the floating-point type FP32, the total number of bits is 32, including 1-bit sign bit, 8-bit exponent bits, 23-bit mantissa bits, and the number of significant bits in mantissa is 23+1=24. For FP16, the total number of bits is 16, including 1-bit sign bit, 5-bit exponent bits, 10-bit mantissa bits, and the number of significant bits in mantissa is 10+1=11. For BF16, the total number of bits is 16, including 1-bit sign bit, 8-bit exponent bits, 7-bit mantissa bits, and the number of significant bits in mantissa is 7+1=8.

In order to represent the maximum number of significant bits in the mantissa, and make the floating-point number have a fixed representation, the coding of floating-point number should adopt a certain specification, which stipulates that the mantissa is given as a pure decimal, and that the absolute value of the mantissa should be greater than or equal to 1/R (usually 2) and less than or equal to 1, i.e., the first bit after the decimal point is not zero, and floating-point numbers that do not meet the specification can be made to meet the specification by modifying the exponent and simultaneously shifting the mantissa. Therefore, for a normalized floating-point number, the highest bit of the mantissa is 1, and the number of significant bits of mantissa is the number of bits of the mantissa plus 1. For example, for a single-precision floating-point number, its mantissa includes 23 bits, and the number of significant bits of its mantissa is 24 bits, and the highest bit is 1.

For a common multiply-accumulate operation in the computing operation, for example, computing multiplication results for a plurality of pairs of input parameters and accumulating these multiplication results, the multiplication result for each pair of input parameters is the product of the two input parameters included in the pair of input parameters. Because different floating-point numbers have different data formats, as illustrated in Table 1, floating-point numbers of different precisions have different total bit-widths, bit-widths of exponent, and bit-widths of mantissa, the computing apparatus used to perform the multiply-accumulate operation is not able to universally support the computing operation of a variety of different floating-point types. Moreover, with the evolution of the deep learning algorithm, BF16 and FP32 have become more mainstream precision types in the inference and training process of the algorithm, and the current deep learning accelerators and the like are unable to support the multiply-accumulate operation of BF16 and FP32.

At least one embodiment of the present disclosure provides a computing apparatus, a computing method, an electronic device, and a non-transient computer-readable storage medium.

The computing apparatus includes: a preprocessing module configured to receive N pairs of input parameters, each pair of input parameters includes two input parameters, where the N pairs of input parameters have a same precision type, and N is a positive integer; perform format conversion on each pair of input parameters according to the precision type of the N pairs of input parameters, and obtain N pairs of processed input parameters after the format conversion, in a process of the format conversion, for each input parameter whose precision type is a first floating-point type, expanding a number of significant bits in a mantissa of the input parameter to a first value, and adding exponent information of the input parameter to the mantissa of the input parameter to obtain a processed input parameter corresponding to the input parameter, the number of significant bits in the mantissa of the input parameter of the first floating-point type is less than or equal to the first value; and a calculation module configured to respectively compute a product of exponents and mantissas of each pair of processed input parameters, and obtain an output result based on the product of exponents and mantissas of each pair of processed input parameters, where the output result is an accumulated sum of N product results corresponding to N pairs of input parameters one by one; the computing apparatus supports multiply-accumulate computation of a plurality of floating-point types.

In at least one embodiment, the computing apparatus first performs format conversion on the input parameter through the preprocessing module, expands the number of significant bits in the mantissa of the input parameter whose number of significant bits in the mantissa is less than the first value to the first value, so that mantissas of all the input parameters of the floating-point type whose number of significant bits in the mantissa less than the first value are processed to the same number of bits. Thereby, it is possible to multiplex the multiplication computation of the mantissa, multiplex the related hardware circuit structure, save the hardware resource, and make the computing apparatus support multiply-accumulate computations in a plurality of precision formats at the cost of lower area and power consumption, and improve the performance of an electronic device adopting the computing apparatus, such as the AI accelerator and the like.

Embodiments of the present disclosure are described in detail below in conjunction with the drawings, but the present disclosure is not limited to these specific embodiments.

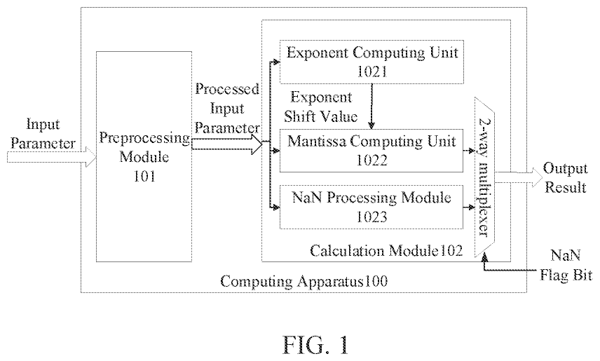

FIG. 1 is a schematic block diagram of a computing apparatus provided by at least one embodiment of the present disclosure.

As illustrated in FIG. 1, the computing apparatus 100 includes a preprocessing module 101 and a calculation module 102.

The preprocessing module 101 is configured to receive N pairs of input parameters, perform format conversion on each pair of input parameters according to the precision type of the N pairs of input parameters, and obtain N pairs of processed input parameters after converting, where N is a positive integer.

The calculation module 102 is configured to respectively compute an exponent product and a mantissa product of each pair of processed input parameters, and obtain an output result based on the exponent product and the mantissa product of each pair of processed input parameters. For example, the output result is an accumulated sum of N product results corresponding to N pairs of input parameters one by one.

For example, each of the N pairs of input parameters may include two input parameters, and the N pairs of input parameters have the same precision type. For example, the product result corresponding to a pair of input parameters is a product of two input parameters included in the pair of input parameters.

For example, the N pairs of input parameters may include N first input parameters and N second input parameters, the first input parameters may be weights, and the second input parameters may be input data. For example, in a convolutional neural network, the first input parameters may be the weight values of each convolutional layer, and the second input parameters may be the input data fed into each convolutional layer.

For example, N may be determined based on the data line bit-width and the precision type of the input parameter. Taking the data line bit-width of 1024 bits as an example, when the precision type of the input parameter is INT8 (8-bit integer), N is up to 128, i.e., the computing apparatus supports the multiply-accumulate computation of at most 128 pairs of input parameters of INT8 at the same time; when the precision type of the input parameter is FP16 or BF16 (16-bit floating-point), N is up to 64, i.e., the computing apparatus supports the multiply-accumulate computation of at most 64 pairs of input parameters of FP16 at the same time; when the precision type of the input parameter is FP32 (32-bit floating-point), N is at most 32, i.e., the computing apparatus supports the multiply-accumulate computation of at most 32 pairs of input parameters of FP32 at the same time. It is to be understood that the person skilled in the art may select a specific value of N based on practical needs.

For example, in some embodiments, a plurality of calculation modules 102, such as 8 calculation modules, may be provided in parallel in the computing apparatus. Each of the calculation modules 102 may simultaneously complete a multiply-accumulate computation of its N pairs of input parameters. For example, if the first input parameters input into each of the computing apparatus 102 are different and the second input parameters are all the same, when the computing apparatus receives the first input parameters, the first input parameters will be cached in a register (e.g., a shadow register) until all the first input parameters necessary for performing a computing operation are obtained; and then all the first input parameters will be assigned to the corresponding calculation modules; when the computing apparatus receives the second input parameters, the second input parameters will be broadcasted to all the calculation modules, each of the calculation modules performs the calculation in parallel, and simultaneously completes and outputs an output result of the multiply-accumulate computation of its N pairs of input parameters.

For example, in the process of the format conversion, for each input parameter whose precision type is a first floating-point type, expanding the number of significant bits in a mantissa of the input parameter to a first value, and adding exponent information of the input parameter to the mantissa of the input parameter to obtain a processed input parameter corresponding to the input parameter. The number of significant bits in the mantissa of the input parameter of the first floating-point type is less than or equal to the first value.

In this embodiment, the mantissa of the input parameter of the floating-point type whose number of significant bits in the mantissa is less than or equal to the first value is expanded to the first value, so that even if the input parameters are of different types, the number of significant bits in the mantissa of the corresponding processed input parameter are the same. Thereby, it is possible to multiplex the same logic of multiplication calculation of the mantissa, multiplex the related hardware circuit structure, save the hardware resource, and make the computing apparatus support multiply-accumulate computations in a plurality of precision formats at the cost of lower area and power consumption, and improve the performance of an electronic device adopting the computing apparatus, such as the AI accelerator and the like.

For example, the preprocessing module 101, when performing format conversion on each pair of input parameters according to the precision type of the N pairs of input parameters, includes performing the following operations: for each input parameter, in response to the precision type of the input parameter being the first floating-point type: discarding the lowest m bits of the exponent of the input parameter, m being a positive integer, performing a complementing operation on the mantissa of the input parameter, shifting the complemented mantissa by a value indicated by the m bits to expand the number of significant bits in the mantissa of the input parameter to the first value to obtain a processed input parameter corresponding to the input parameter.

For example, in some embodiments, the first value is 15, and the first floating-point type may include BF16 and FP16, as illustrated in Table 1, numbers of significant bits in the mantissa of BF16 and FP16 are different and are both less than the first value of 15. By format conversion, the number of significant bits in the mantissa of the input parameter of the type of BF16 or FP16 are both expanded to 15 bits, so that for the input parameter of the type of either BF16 or FP16, the same hardware structure may be used to complete the product calculation of the mantissa.

Of course, the present disclosure is not limited thereto, and depending on the type of floating-point of the input parameter to be processed, a range of the first value and the type of the first floating-point may be set as desired, and the present disclosure does not impose any specific limitations thereon.

For example, the complementing operation includes adding a 1 in front of the most significant bit of the mantissa of the input parameter.

For a normalized floating-point number, the most significant bit in the mantissa is 1, so in order to represent the maximum number of significant bits in the mantissa, the most significant bit of the mantissa is usually hidden, which also known as an implicit bit.

For example, for the normalized floating-point number, at least the implicit bit of the mantissa is complemented in the complementing operation, i.e., a 1 is complemented in front of the most significant bit of the mantissa of the input parameter.

For example, for an unnormalized floating-point number, a 0 may be complemented in front of the most significant bit of the mantissa of the input parameter in the complementing operation.

Of course, according to the requirement of the number of bits, if the mantissa is not able to be expanded to the first value only by shifting the mantissa after complementing the implicit bit by a value indicated by the m bits, the complementing operation may further include continuing to add at least one 0 at a higher bit of the implicit bit after complementing the implicit bit until it is able to expand the mantissa to the first value after shifting the complemented mantissa by a value indicated by the m bits.

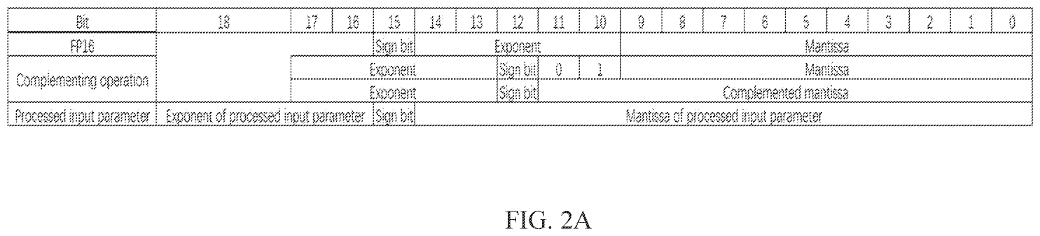

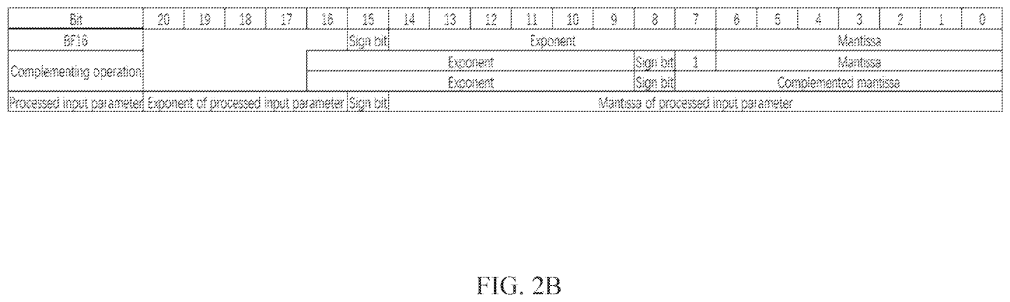

FIG. 2A is a schematic diagram of a process of format conversion provided by an embodiment of the present disclosure, and FIG. 2B is a schematic diagram of a process of format conversion provided by another embodiment of the present disclosure. For example, FIG. 2A illustrates a specific process of format conversion by the preprocessing module 101 for input parameters of type FP16, and FIG. 2B illustrates a specific process of format conversion by the preprocessing module 101 for input parameters of type BF16.

The following combines FIG. 2A and FIG. 2B to specify a processing flow of the preprocessing module 101 provided by at least one embodiment of the present disclosure.

As illustrated in FIG. 2A, for the input parameter of the FP16 type, the total number of bits is 16, including 1-bit sign bit (15th bit in FIG. 2A), the exponent includes 5 bits (10th to 14th bits in FIG. 2A), and the mantissa includes 10 bits (0th to 9th bits in FIG. 2A).

In the process of format conversion, for the exponent, the lowest 2 bits of the exponent of the input parameter are discarded, i.e., for FP16, m =2. In the processed input parameter, the 3 bits of its exponent are the 12th to 14th bits of the original input parameter, thus compressing the number of bits of the exponent from 5 to 3, saving the logic of processing the exponent.

For the mantissa, as illustrated in the complementing operation in FIG. 2A, the implicit bit is first complemented by adding a 1 in front of the most significant bit (9th bit) of the mantissa of the input parameter, i.e., the 10th bit is complemented with a 1 as illustrated in FIG. 2A; and, further, a 0 is complemented in front of the complemented implicit bit, i.e., the 11th bit is added with a 0 as illustrated in FIG. 2A, thereby obtaining the complemented mantissa. After the complementing operation, the mantissa is expanded to 12 bits.

After that, the complemented mantissa is shifted to the value indicated in the lowest 2 bits of the exponent of the input parameter, up to 3 bits (in this case, the lowest 2 bits of the exponent of the input parameter are “11”), so that the processed input parameter can be expanded to 15 bits. For example, if the lowest 2 bits of the exponent of the input parameter is “00”, it means shifting by 0 bit, i.e., in the mantissa of the processed input parameter, the lower 12 bits are the complemented mantissa, and the higher 3 bits are 0; if the lowest 2 bits of the exponent of the input parameter is “01”, it means shifting by 1 bit, i.e., in the mantissa of the processed input parameter, the 1st to 12th bits are the complemented mantissa, the 13th, 14th and 0th bits are 0; if the lowest 2 bits of the exponent of the input parameter are “10”, it means shifting by 2 bits, i.e., in the mantissa of the processed input parameter, the 2nd to 13th bits are the complemented mantissa, and the 14th, 0th and 1st bits are 0; if the lowest 2 bits of the exponent of the input parameter are “11”, it means shifting by 3 bits, i.e., in the mantissa of the processed input parameter, the 3rd to 14th bits are the complemented mantissa, and the lower three bits are 0.

As illustrated in FIG. 2B, for an input parameter of type BF16, the total number of bits is 16, including 1-bit sign bit (15th bit in FIG. 2B), the exponent (i.e., exponent) includes 8 bits (7th to 14th bits in FIG. 2B), and the mantissa includes 7 bits (0th to 6th bits in FIG. 2B).

In the process of format conversion, for the exponent, the lowest 3 bits of the exponent of the input parameter are discarded, i.e., for BF16, m=3. In the processed input parameter, the 5 bits of its exponent are the 10th to 14th bits of the original input parameter, thus compressing the number of bits of the exponent from 8 to 5, saving the logic of processing the exponent.

For the mantissa, as illustrated in the complementing operation in FIG. 2A, the implicit bit is first complemented, and a 1 is added in front of the highest bit (6th bit) of the mantissa of the input parameter, as illustrated in FIG. 2B, a 1 is added in the 7th bit. As a result, the complemented mantissa is obtained, and the mantissa is expanded to 8 bits after the complementing operation.

After that, the complemented mantissa is shifted to the value indicated in the lowest 3 bits of the exponent of the input parameter, up to 7 bits (in this case, the lowest 3 bits of the exponent of the input parameter is “111”), so that the processed input parameter can be expanded to 15 bits. For example, if the lowest 3 bits of the exponent of the input parameter is “101”, it means shifting by 5 bits, i.e., in the mantissa of the processed input parameter, the 5th to 12th bits are the complemented mantissa, and the 13th and 14th bits and the 0th to 4th bits are all 0; if the lowest 3 bits of the exponent of the input parameter is “111”, it means shifting by 7 bits, i.e., in the mantissa of the processed input parameter, the 7th to 14th bits are the complemented mantissa, and the lower 7 bits are 0. For the input parameter exponent of the lowest 3 bits for other values of the case is similar to the above process, which will not be repeated.

It should be noted that because the sign bit is also involved in the multiplication calculation of the mantissa, the sign bit is set in front of the most significant bit of the mantissa in the processed input parameter, i.e., the 15th bit. In the later section, for the FP16 and the BF16, the mantissa is involved in the calculation of 16 bits, including the 15 bits of the mantissa and the 1 bit of the sign bit.

For example, in the above embodiment, the lowest m bits of the exponent of the input parameter are discarded to reduce the bit-width of the exponent and effectively simplify the calculation logic of the exponent; the complemented mantissa is shifted by the value indicated by the m bits in order to add the exponent information of the input parameter to the mantissa of the input parameter, which reduces the effect of the precision of the computation result; and the precision preprocessing for the floating-point can fully multiplex the calculation logic and the hardware resource of the multiplication portion. For each input parameter of the first floating-point type, the above pre-processing can be performed, the mantissas of the processed input parameters have the same number of bits, and the same data processing path can be fully multiplexed. Thereby, it is possible to significantly save the hardware resource, minimize the consumption of the hardware resource, and make the computing apparatus support multiply-accumulate computations in a plurality of precision formats at the cost of lower area and power consumption.

For example, in response to the significant bits in mantissa of the input parameter being equal to the first value, the input parameter is directly taken as the processed input parameter corresponding to the input parameter.

For example, in response to the precision type of the input parameter being a second floating-point type, because the number of significant bits in the mantissa of the input parameter thereof is greater than the first value, the above-described format conversion may not be performed on the exponent of the input parameter of the second floating-point type, and an implicit bit 1 may be added in front of the most significant bit of the mantissa of the input parameter of the second floating-point type, thereby obtaining the processed input parameter corresponding to the input parameter of the second floating-point type.

For example, the second floating-point type may include FP32, as illustrated in Table 1, whose total number of bits is 32, including 1-bit sign bit, 8-bit exponent bits, 23-bit mantissa bits, and the number of significant bits of mantissa is 23+1=24. When the multiplication calculation on the mantissa is performed, the mantissa is 25 bits, including 1 sign bit, 1 complemented implicit bit, and 23 bits of the original input parameter. For the FP32, the exponent is not specially processed in the preprocessing module, and the mantissa is complemented with the implicit bit to obtain the processed input parameter input to the calculation module 102.

As illustrated in FIG. 1, the computing module 102 includes an exponent computing unit 1021 and a mantissa computing unit 1022.

For example, the exponent computing unit 1021 is configured to perform calculation on exponents of each pair of processed input parameters to obtain an exponent shift value corresponding to each pair of processed input parameters. For example, the exponent shift value indicates a difference between the summing result of exponents of each pair of processed input parameters relative to a maximum exponent value, the maximum exponent value is the maximum value among summing results of exponents of the N pairs of processed input parameters. For example, the exponent shift value is used to shift the mantissa product result so that the exponents of the product results of the N pairs of processed input parameters are the same, i.e., they are all the maximum exponent value, so that the accumulation computation may be performed directly without considering the difference in exponents.

For example, the mantissa computing unit 1022 is configured to perform a multiplication calculation on mantissas of each pair of processed input parameters in combination with the exponent shift value corresponding to each pair of processed input parameters to obtain the output result.

For example, the exponent computing unit 1021 includes a first subunit, a second subunit, and an output subunit.

For example, the first subunit is configured to: compute in parallel sums of exponents of N1 pairs of processed input parameters to obtain N1 exponent computation results, and determine the maximum value of the N1 exponent computation results as a first maximum value. For example, the N1 pairs of processed input parameters are obtained by performing format conversion on N1 pairs of input parameters of the first floating-point type, and each exponent computation result is a sum of the exponents of the two processed input parameters included in each pair of processed input parameters, i.e., in the present disclosure, when multiplication computation of the input parameters is performed, a product of the exponents is essentially a sum of the exponents, and the summing result is used as the exponent computation result.

For example, the second subunit is configured to: compute in parallel sums of exponents of N2 pairs of processed input parameters to obtain N2 exponent computation results, and determine the maximum value of the N2 exponent computation results as a second maximum value, where N1 and N2 are positive integers, and N1+N2 is equal to N; alternatively, compute in parallel sums of exponents of the N pairs of processed input parameters to obtain N exponent computation results, and determine the maximum value of the N exponent computation results as a second maximum value. For example, the N2 pairs of processed input parameters are obtained by performing format conversion on N2 pairs of input parameters of the first floating-point type.

For example, the output subunit is configured to: determine a larger value between the first maximum value and the second maximum value as the maximum exponent value; and compute a difference between a sum result of exponents of each pair of processed input parameters relative to the maximum exponent value to obtain the exponent shift value corresponding to each pair of processed input parameters.

For example, specific values of N1 and N2 may be specified according to actual needs, such as, in an example, N1=N2=N/2.

For example, if the processed input parameter is obtained after performing format conversion on the input parameter of the first floating-point type, the first subunit may simultaneously process the product of exponents of N1 pairs of processed input parameters, and the second subunit may simultaneously process the product of exponents of N2 pairs of processed input parameters, thereby simultaneously computing the product of exponents of N pairs of processed input parameters.

For example, if the processed input parameter is obtained after performing format conversion on the input parameter of the second floating-point type, the second subunit simultaneously processes the exponent products of N pairs of processed input parameters.

As a result, the computing apparatus may simultaneously support the computation of exponents of the input parameters of a plurality of floating-point types, multiplex as much hardware calculation logic, such as an adder, as possible.

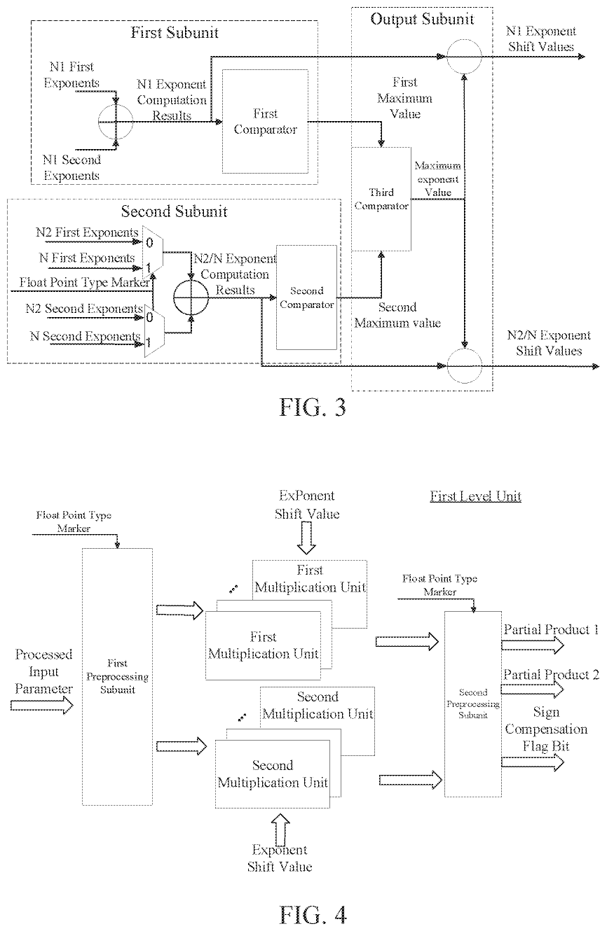

FIG. 3 is a structural diagram of an exponent computing unit provided by at least one embodiment of the present disclosure.

As illustrated in FIG. 3, the exponent computing unit includes a first subunit, a second subunit, and an output subunit.

In FIG. 3, a pair of processed input parameters includes a first processed input parameter and a second processed input parameter, N1 first exponents and N1 second exponents are the exponents of the processed input parameters obtained by format conversion of the N1 pair of input parameters of the first floating-point type, and N2 first exponents and N2 second exponents are the exponents of the processed input parameters obtained by format conversion of the N2 pair of input parameters of the first floating-point type. N first exponents and N second exponents in FIG. 3 are the exponents of the processed input parameters obtained by format conversion of the N pairs of input parameters of the second floating-point type.

For example, if the first floating-point type includes BF16 and FP16, the second floating-point type includes FP32, and the data line bit-width is 1024 bits, then in FIG. 3, N1=N2=N=32, indicating that the exponent computing unit may simultaneously perform calculations on exponents of 64 pairs of input parameters of BF16 and FP16, or perform calculations on exponents of 32 pairs of input parameters of FP32. It should be noted that the specific values of N1, N2 and N are different when the types of the input parameters are different. For the input parameters of BF16 and FP16, N is still the sum of N1 and N2, i.e., 64, but for the input parameters of FP32,N=32 and N1=N2=0. In FIG. 3, however, N1, N2, and N correspond to floating-points of different types, and for N1, N2, and N itself in FIG. 3, the relationship N1+N2=N is not satisfied.

For example, as illustrated in FIG. 3, the first subunit includes N1 adders and a first comparator. The N1 adders are used to compute in parallel sums of exponents of N1 pairs of processed input parameters, and to output N1 exponent computation results. The first comparator is used to determine the maximum value of the N1 exponent computation results as a first maximum value.

For example, as illustrated in FIG. 3, the second subunit includes 2 multiplexers, N2 or N adders, and a second comparator.

The 2 multiplexers are used to select one of the input parameter and output it to the adder based on a floating-point type marker. For example, the floating-point type marker includes a first marker (e.g., 0) indicating a first floating-point type and a second marker (e.g., 1) indicating a second floating-point type. If the floating-point type marker is the first marker, both of the 2 multiplexers select 0-way to output, thereby outputting N2 first exponents and N2 second exponents to the adder, and if the floating-point type marker is the second marker, both of the 2 multiplexers select 1-way to output, thereby outputting N first exponents and N second exponents to the adder.

The N2 adders are used to compute in parallel sums of exponents of N2 pairs of processed input parameters, and output the N2 exponent computation results, where the N2 pairs of processed input parameters are obtained by performing format conversion on N2 pairs of input parameters of the first floating-point type; alternatively, the N adders are used to compute in parallel sums of exponents of the N pairs of processed input parameters, output the N exponent computation results, where the N pairs of processed input parameters are obtained by performing format conversion on N pairs of input parameters of the second floating-point type.

The second comparator is used to determine the maximum value of the N2 or N exponent computation results as a second maximum value.

The output subunit includes a third comparator and a plurality of subtractors.

The third comparator is used to determine the larger of the first maximum value and the second maximum value as the maximum exponent value.

For example, if the input parameters are of FP16 or BF16, the input parameters are divided into two ways by the first subunit and the second subunit, and each of the two ways computes sums of exponents of 32 pairs of processed input parameters to obtain 64 exponent computation results simultaneously, so that the maximum value of the 64 exponent computation results is selected through the third comparator to be used as the maximum exponent value.

For example, if the input parameters are of FP32, the output result of the first subunit is null, i.e., the first maximum value is null, and the maximum value among the 32 exponent computation results computed by the second subunit is taken as the maximum exponent value, i.e., the maximum exponent value is the second maximum value.

The subtractor is used to calculate the difference between each of the exponent computation results and the maximum exponent value, thereby obtaining the exponent shift value corresponding to each pair of processed input parameters.

For example, the data bit-width processed by the first subunit is determined based on the largest number of significant bits of exponent among numbers of significant bits of exponent of the processed input parameter corresponding to the input parameter of the first floating-point type. For example, the data bit-width processed by the second subunit is determined based on the largest exponent bit-width among exponent bits of the processed input parameter corresponding to the input parameter of the second floating-point type.

For example, taking the first floating-point type including BF16 and FP16 and the second floating-point type including FP32 as an example, the data bit-width processed by the first subunit is 6 bits, because the exponent of BF16 has a bit-width of 5 bits after preprocessing, the exponent product corresponding to the two input parameters of BF16 is 6 bits. The bit-width of the exponent of FP16 after preprocessing is 3 bits, and the exponent product corresponding to the two input parameters of FP16 is 4 bits, and in order to be able to process the input parameters of BF16 and FP16 simultaneously, the largest number of exponent bits of the two is selected to determine the data bit-width processed by the first subunit, i.e., the data bit-width to be processed by the first subunit is determined to be 6 bits. Similarly, the data bit-width processed by the second subunit is 9 bits, because the bit-width of the exponent of FP32 is 8 bits, and in order to be able to process the input parameters of BF16 and FP32 simultaneously, the largest number of significant bits of exponent of the two is selected to determine the data bit-width processed by the second subunit, i.e., the data bit-width processed by the second subunit is determined to be 9 bits. The exponent computing unit is also able to fully multiplex the circuit logic by adjusting the data bit-width supported by the hardware resource, for example, for the input parameter of the first floating-point type, its exponent can both be computed by the first subunit and the second subunit without data overflow.

In this embodiment, the first subunit can complete 32 pairs of exponent multiplications and find out the maximum value as the first maximum value, the second subunit can complete 32 pairs of exponent multiplications and find out the maximum value as the second maximum value, and then the maximum exponent value is found out after the outputs of the first subunit and the second subunit are converged. The circuit structure supports a plurality of precision types such as FP16, BF16, FP32, etc., minimizes the hardware resource as much as possible and multiplexes more hardware circuit logic.

For example, the mantissa computing unit 1022 includes multiplication units of at least two precision types, the multiplication units of at least two precision types including a first multiplication unit and a second multiplication unit. The first multiplication unit and the second multiplication unit both supports a multiplication calculation on a mantissa of a processed input parameter corresponding to the input parameter of the first floating-point type, and in addition, the second multiplication unit supports a multiplication calculation on a mantissa of a processed input parameter corresponding to an input parameter of a second floating-point type.

For example, the mantissa computing unit includes a first level unit, a second level unit, and a third level unit.

The first level unit is configured to compute in parallel mantissa products of the N pairs of processed input parameters using a plurality of multiplication units in combination with the exponent shift value corresponding to each pair of processed input parameters, and output N sets of intermediate results respectively corresponding to the N pairs of processed input parameters, each set of intermediate results including two partial products and a sign compensation flag bit.

The second level unit is configured to perform at least one Wallace tree compression on partial products of the N sets of intermediate results to obtain a compression result.

The third level unit is configured to obtain the output result using an adder in combination with sign compensation flag bits in the N sets of intermediate results and the compression result.

FIG. 4 is a schematic block diagram of a first level unit provided by at least one embodiment of the present disclosure.

As illustrated in FIG. 4, the first level unit includes a first preprocessing subunit, a plurality of first multiplication units, a plurality of second multiplication units, and a second preprocessing subunit.

For example, in order to multiplex the data path as much as possible and improve the transmission and processing efficiency, when transmitting data between modules, the data bit-width may be set in accordance with the input parameter of the second floating-point type, and a plurality of parameters of the first floating-point type are spliced together, so that the bit-width thereof can occupy the entire data bit-width as much as possible. For example, taking the first floating-point type including FP16 and BF16 and the second floating-point type including FP32 as an example, the data bit-width may be set to 32 bits, so that the bit-width of the mantissa of the input parameter of the second floating-point type that performs the mantissa multiplication computation is 25 bits, the bit-width of the mantissa of the input parameter of the first floating-point type is 16 bits, and mantissas of 2 input parameters of the first floating-point type may be spliced to fully occupy the 32-bit data bit-width.

The first preprocessing subunit is used to split the input processed input parameters and input them to corresponding multiplication units according to the floating-point type marker. For example, if the floating-point type marker indicates that the input mantissas are obtained by preprocessing input parameters of the first floating-point type, the input mantissas are split, for example, into two groups to be input into the first multiplication unit and the second multiplication unit, respectively; for example, if the floating-point type marker indicates that the input mantissas are obtained by preprocessing input parameters of the second floating-point type, the input mantissas are input into a corresponding second multiplication unit.

The plurality of first multiplication units and the plurality of second multiplication units are used to compute the mantissa products of the input processed parameters in parallel in combination with exponent shift values, and the specific structure and computing process are described later.

For example, the first floating-point type includes FP16 and BF16, the second floating-point type includes FP32, the first multiplication unit is a 16-bit multiplier, and the second multiplication unit is a 24-bit multiplier. Taking a data line bit-width of 1024 bits as an example, 32 24-bit multipliers and 32 16-bit multipliers may be included in the first level unit for completing multiplication calculations of 64 pairs of mantissas of BF16/FP16 in parallel, the 32 24-bit multipliers may also complete multiplication calculations of 32 pairs of mantissas of FP32 in parallel.

The second preprocessing subunit corresponds to the first preprocessing subunit for splicing the computation results of the multiplication unit according to the floating-point type marker. For example, if the floating-point type mark indicates that the input mantissa is obtained by preprocessing the input parameters of the first floating-point type, the intermediate results output by the multiplication unit are spliced, for example, every two partial products or every two sign bits are spliced together, and the specific process is the opposite of the splitting process of the first preprocessing subunit, which will not be further described herein.

As illustrated in FIG. 4, the second preprocessing subunit outputs the final N sets of intermediate results, and each set of intermediate results includes 2 partial products (partial product 1, partial product 2 in FIG. 4) and a sign compensation flag bit.

As a result of the preprocessing, the number of significant bits in the mantissa of the input parameter of BF16 and the number of significant bits in the mantissa of the input parameter of FP16 are both the first value, so that the same computing path can be multiplexed; moreover, the 32 24-bit multipliers are structured so that they can support both mantissa computations of the first floating-point type and the second floating-point type, which enables the computing apparatus to support mantissa multiplication calculations of different precision types of floating-point, saving the hardware resource on the data path, maximizing the multiplexing of multiplier logic, adding support for calculations of more precision types at the cost of lower area and power consumption, and improving the performance of the computing apparatus in performing the multiply-accumulate computation.

For example, the first multiplication unit, when performing a multiplication calculation on the mantissa of the processed input parameter corresponding to the input parameter of the first floating-point type, includes performing the following operations: obtaining, with respect to an i-th pair of processed input parameters, L partial products corresponding to the i-th pair of processed input parameters by a Booth multiplier, L being a positive integer; performing at least one Wallace tree compression on the L partial products to obtain a first intermediate compression result; shifting the first intermediate compression result according to an exponent shift value corresponding to the i-th pair of processed input parameters to obtain two partial products of a set of intermediate results corresponding to the i-th pair of processed input parameters; shifting a sign compensation reference constant based on an exponent shift value corresponding to the i-th pair of processed input parameters to obtain a sign compensation flag bit of the set of intermediate results corresponding to the i-th pair of processed input parameters, i being a positive integer.

For example, each multiplication unit performs a multiplication calculation of mantissas of a pair of processed input parameters, so that a plurality of multiplication units may output the multiplication calculation results of mantissas of all the processed input parameters in parallel. Instead of directly outputting the final result, the multiplication unit outputs an intermediate result including 2 partial products and a sign compensation flag bit to save as much as possible the number of adders used for accumulation computation on the subsequent data paths.

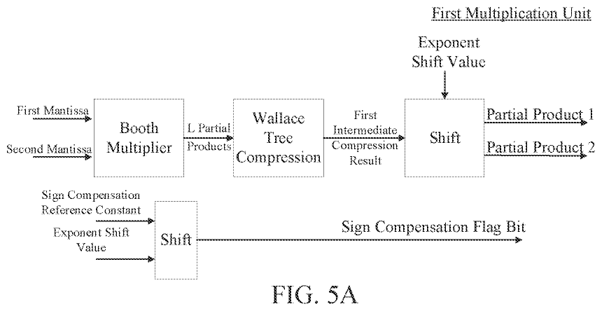

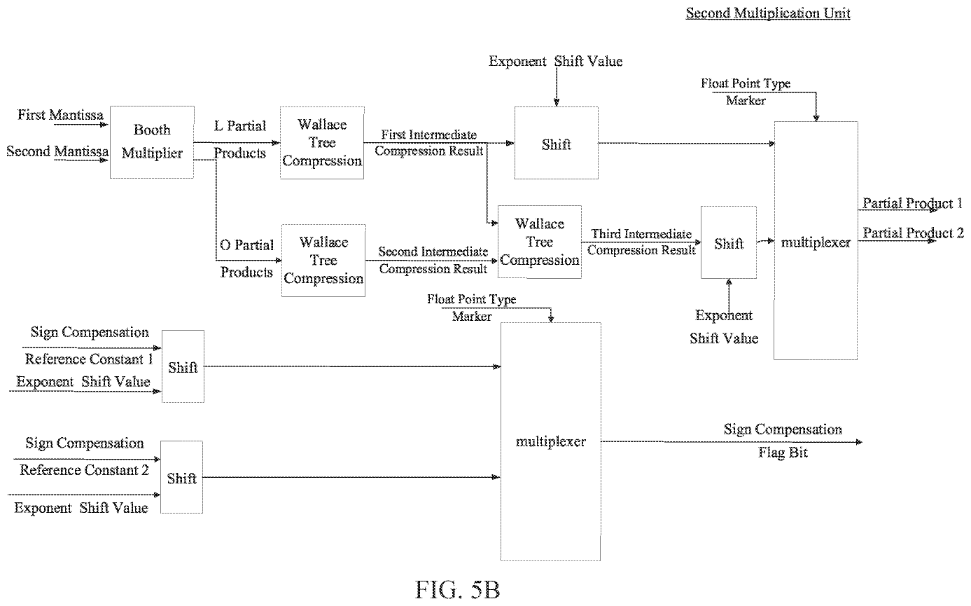

FIG. 5A is a schematic block diagram of a first multiplication unit provided in at least one embodiment of the present disclosure.

For example, for the first multiplication unit illustrated in FIG. 5A, it is used to perform a multiplication calculation of mantissas of the i-th pair of processed input parameters. The i-th pair of processed input parameters is obtained by performing format conversion on an input parameter of the first floating-point type. The i-th pair of processed input parameters includes a first processed input parameter and a second processed input parameter, the first mantissa in FIG. 5A is the mantissa of the first processed input parameter, and the second mantissa is the mantissa of the second processed input parameter.

As illustrated in FIG. 5A, first, the product result of the first mantissa and the second mantissa, i.e., L partial products, is obtained through a Booth multiplier.

Afterwards, in order to economize the number of adders on the subsequent paths as much as possible, the L partial products are subjected to at least one Wallace tree compression to obtain a first intermediate compression result.

Afterwards, the first intermediate compression result is shifted according to the exponent shift value corresponding to the i-th pair of processed input parameters computed by the exponent computing unit to obtain the partial product 1 and the partial product 2. As a result of the shifting, the partial products 1 (res_a) and the partial products 2 (res_b) obtained from the mantissas of all the processed input parameters correspond to the same exponent value, i.e., the maximum exponent value, so that the summing calculation can be done directly without considering the difference in exponent during the summing process.

The sign compensation reference constant is shifted according to the exponent shift value corresponding to the i-th pair of processed input parameters to obtain the sign compensation flag bit, the sign compensation flag bit is used for computing the sign compensation value when summing the product result of N pairs of input parameters.

For example, the product result of the first mantissa and the second mantissa may be represented by two partial products (res_a and res_b) in the intermediate result and a sign compensation value obtained based on the sign compensation flag bit.

For example, the sign compensation reference constant is related to the type of the processed input parameter, e.g., in response to the first floating-point type being BF16 or FP16, the sign compensation reference constant is 0xF0, and as a result of preprocessing, some of the exponent bits of the input parameter are discarded and the exponent information of the input parameter is added to the mantissa of the input parameter. Thereby, for the processed input parameter, the exponent shifted by 1 bit may indicate that the exponent of the input parameter is shifted by more than one bit, and a sign compensation parameter with fewer bits may be used for obtaining the sign compensation flag bit, saving the hardware resource.

In a specific example, for example, the first floating-point type includes BF16 and FP16, the first multiplication unit is a 16-bit multiplier, and when the first multiplication unit performs a multiplication calculation on the mantissa of the processed input parameter corresponding to the input parameter of the BF16 or the FP16, firstly, the product result of the first mantissa and the second mantissa (i.e., 10 partial products) is obtained through the Booth multiplier; afterwards, the 10 partial products are subjected to Wallace tree compression twice, the 10 partial products are compressed into 4 intermediate partial products in the first compression, and the 4 intermediate partial products are compressed into 2 intermediate partial products again in the second compression, and the 2 intermediate partial products are taken as the first intermediate compression result; afterwards, the first intermediate compression result is shifted according to the exponent shift value corresponding to the i-th pair of processed input parameters to obtain two partial products (i.e., partial product 1 and partial product 2) of a set of intermediate results corresponding to the i-th pair of processed input parameters; and the sign compensation reference constant 0xF0 is shifted according to the exponent shift value corresponding to the i-th pair of processed input parameters to obtain a sign compensation flag bit.

In the above embodiment, the use of a Booth multiplier can minimize the number of partial products, and the use of Wallace tree compression can improve the parallelism of the summing of the partial products, thereby maximizing the computational efficiency as much as possible.

For the second multiplication unit, it can perform both a multiplication calculation of the first floating-point type and a multiplication calculation of the second floating-point type.

For example, the second multiplication unit, when performing a multiplication calculation on the mantissa of the processed input parameters corresponding to the input parameter of the second floating-point type, includes performing the following operations: obtaining, with respect to an i-th pair of processed input parameters, L+O partial products corresponding to the i-th pair of processed input parameters by a Booth multiplier, both L and O being positive integers; performing at least one Wallace tree compression on L partial products to obtain a first intermediate compression result; performing at least one Wallace tree compression on O partial products to obtain a second intermediate compression result; performing at least one Wallace tree compression on the first intermediate compression result and the second intermediate compression result to obtain a third intermediate compression result; shifting the third intermediate compression result according to an exponent shift value corresponding to the i-th pair of processed input parameters to obtain two partial products of a set of intermediate results corresponding to the i-th pair of processed input parameters; shifting a sign compensation reference constant based on an exponent shift value corresponding to the i-th pair of processed input parameters to obtain a sign compensation flag bit of a set of intermediate results corresponding to the i-th pair of processed input parameters, i being a positive integer.

FIG. 5B is a schematic structural diagram of a second multiplication unit provided in at least one embodiment of the present disclosure.

For example, for the second multiplication unit illustrated in FIG. 5B, it is used to perform a multiplication calculation of a mantissa of the i-th pair of processed input parameters. The i-th pair of processed input parameters is obtained by performing format conversion on an input parameter of the second floating-point type or the first floating-point type. The i-th pair of processed input parameters includes a first processed input parameter and a second processed input parameter, the first mantissa in FIG. 5B is a mantissa of the first processed input parameter, and the second mantissa is a mantissa of the second processed input parameter.

As illustrated in FIG. 5B, firstly, the product result of the first mantissa and the second mantissa is obtained through a Booth multiplier, for example, if the first mantissa and the second mantissa are mantissas obtained by format conversion on input parameters of the first floating-point type, the product result is L partial products, and if the first mantissa and the second mantissa are mantissas obtained by format conversion on input parameters of the second floating-point type, the product result is L+O partial products.

For example, if the first mantissa and the second mantissa are the mantissas obtained by format conversion on input parameters of the first floating-point type, then for the L partial products, similar to the process of the first multiplication unit, as illustrated in FIG. 5B, the first intermediate compression result is first obtained after at least one Wallace tree compression; afterwards, the first intermediate compression result is shifted according to the exponent shift value corresponding to the i-th pair of processed input parameters; afterwards, the result after shifting is selected to output via a multiplexer according to the floating-point type marker, to obtain two partial products (partial product 1 and partial product 2 in FIG. 5B) of a set of intermediate results corresponding to the i-th pair of processed input parameters.

The sign compensation reference constant 1 (corresponding to the sign compensation parameter of the first floating-point type, for example, 0xF0) is shifted based on the exponent shift value corresponding to the i-th pair of processed input parameters, and thereafter, the result after shifting is selected to output according to the floating-point type marker via a multiplexer, to obtain the sign compensation flag bit in the set of intermediate results corresponding to the i-th pair of processed input parameters.

The specific flow about the above process is similar to that of the first multiplication unit, and the specific process will not be repeated.

For example, if the first mantissa and the second mantissa are mantissas obtained by format conversion on input parameters of the second floating-point type, the L+O partial products are processed separately into two paths.

For the L partial products, a first intermediate compression result is first obtained after at least one Wallace tree compression, and for the O partial products, a second intermediate compression result is obtained after at least one Wallace tree compression; thereafter, at least one Wallace tree compression is performed on the first intermediate compression result and the second intermediate compression result to obtain a third intermediate compression result; thereafter, the third intermediate compression result is shifted according to the exponent shift value corresponding to the i-th pair of processed input parameters; thereafter, outputting the result after shifting according to the floating-point type marker via a multiplexer to obtain two partial products (partial product 1 and partial product 2 in FIG. 5B) of a set of intermediate results corresponding to the i-th pair of processed input parameters. Similarly, as a result of the shifting, the partial product 1 (res_a) and the partial product 2 (res_b) obtained from the mantissas of all the processed input parameters correspond to the same exponent value (exponent value), i.e., the maximum exponent value, so that the summing calculation can be done directly without considering the difference in exponent during the summing process.

The sign compensation reference constant 2 (corresponding to the sign compensation parameter of the second floating-point type, which is different from the sign compensation reference constant 1) is shifted based on the exponent shift value corresponding to the i-th pair of processed input parameters, and then outputting the result after shifting according to the floating-point type marker via a multiplexer to obtain the sign compensation flag bit of a set of intermediate results corresponding to the i-th pair of processed input parameters.

For example, in other examples, the second multiplication unit may not be provided with a multiplexer for selecting a sign compensation flag bit for output, i.e., the second multiplication unit may simultaneously output the sign compensation flag bit 1 for the first floating-point type (e.g., obtained by shifting the sign compensation reference constant 1) and the sign compensation flag bit 2 for the second floating-point type (e.g., obtained by shifting the sign compensation reference constant 2). And subsequently, when computing the sign compensation value, the corresponding sign compensation flag bit is selected for computation according to different floating-point types. For example, the sign compensation reference constant is related to the type of the input parameter to be processed, and for the second floating-point type, the sign compensation parameter is different from that of the first floating-point type because it does not discard some of the exponent bits in the preprocessing process. For example, in response to a second floating-point type of FP32, the sign compensation reference constant is 0x2 aaaa aa00 0000.

In a specific example, for example, the second floating-point type includes FP32, the second multiplication unit is a 24-bit multiplier, and when the second multiplication unit performs a multiplication calculation on the mantissa of the processed input parameter corresponding to the input parameter of FP32, firstly, the product result of the first mantissa and the second mantissa (i.e., 10+6 partial products) are obtained through the Booth multiplier; afterwards, the 10 partial products are compressed 2 times by Wallace tree compression, the 10 partial products are compressed into 4 intermediate partial products in the first compression, and the 4 intermediate partial products are compressed into 2 intermediate partial products again in the second compression, and the 2 intermediate partial products are taken as the first intermediate compression result; the 6 partial products are compressed once by Wallace tree compression, and the 6 intermediate partial products are compressed into 2 intermediate partial products, and the 2 intermediate partial products are taken as the second intermediate compression result; afterwards, the first intermediate compression result and the second intermediate compression result are compressed once by Wallace tree compression to obtain 2 intermediate partial products as the third intermediate compression result; afterwards, the third intermediate compression result is shifted according to the exponent shift value corresponding to the i-th pair of processed input parameters to obtain two partial products (i.e., partial product 1 and partial product 2) of a set of intermediate results corresponding to the i-th pair of processed input parameters; and the sign compensation reference constant 0x2 aaaa aa00 0000 is shifted according to the exponent shift value corresponding to the i-th pair of processed input parameters to obtain a sign compensation flag bit.

In the above embodiment, because the number of partial products obtained by multiplying the mantissas of the input parameters of the second floating-point type is much larger, the second multiplication unit can divide the partial products obtained by the Booth multiplier into two different channels to be processed separately, where the L partial products can be processed using the same structure as that of the first multiplication unit, and the O partial products are processed separately, which can enable the second multiplication unit to support both the multiplication calculation on the mantissa of the first floating-point type and the multiplication calculation on the mantissa of the second floating-point type, multiplexing the hardware circuitry as much as possible and minimizing the consumption of hardware resource.

For example, in some embodiments, the O partial products obtained in the second multiplication unit may also be transmitted to an idle first multiplication unit to perform subsequent Wallace tree compression without setting the hardware path for the O partial products in FIG. 5B, at which time the Wallace tree compression portion in the first multiplication unit may be multiplexed to save the hardware resource and improve computing efficiency.

The second level unit is used to further compress the N sets of intermediate results output by the first level unit, for example, to further compress the partial product 1 and the partial product 2 in the N sets of intermediate results using the Wallace tree, so that the partial products in the N sets of intermediate results output by the multiplication unit are finally compressed into two intermediate numbers as the compression result.

For example, for an input parameter of the first floating-point type, such as FP16 or BF16, the input of the second level unit is 64 pairs of partial products, each pair of partial products is two partial products (res_a and res_b) of a set of intermediate results corresponding to a pair of processed input parameters, and the output is two intermediate numbers after compression.

For example, for an input parameter of the second floating-point type, such as FP32, the input of the second level unit is 32 pairs of partial products, each pair of partial products is two partial products (res_a and res_b) of a set of intermediate results corresponding to a pair of processed input parameters, and the output is two intermediate numbers after compression.

For example, in the process of Wallace tree compression, each Wallace tree compression is performed in a format of a calculation result of at least one channel, the calculation result of each channel includes at least one product term.

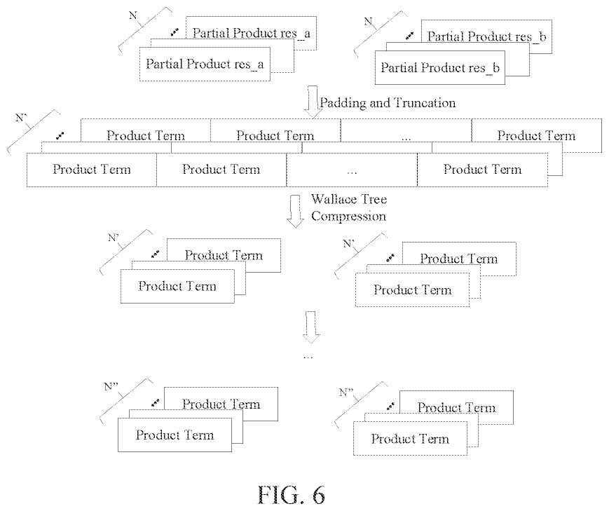

FIG. 6 is a schematic diagram of a compression process of a second level unit provided by at least one embodiment of the present disclosure.

As illustrated in FIG. 6, the input of the second level unit is N pairs of partial products, and the N pairs of partial products are N partial products res_a and N partial products res_b in FIG. 6, respectively.

The N pairs of partial products are first padded and truncated to be converted into calculation results of N′ channels, each channel includes the same number of a plurality of product terms.

After that, Wallace tree compression is performed on the calculation results of N′ channels to obtain a Wallace tree compression result. Afterwards, the above padding and compression process continues to be repeated, and after a plurality of padding and compression processes, 2 intermediate numbers are obtained as the compression result, each intermediate number includes calculation results of N″ channels, and each calculation result includes 1 product term.

For example, in some embodiments, in order to maximize the multiplexing of the logic of the Wallace tree, the precision with the maximum input and output bit-widths when performing Wallace tree compression is selected as the basic data path of the Wallace tree. By multiplexing the circuit of the Wallace tree, it supports compression of other precisions and minimize the hardware resource consumption as much as possible.

For example, in the Wallace tree compression process, for each product term in the calculation result with the same number of channels, a number of bits of the product term is a second value, the second value is determined based on the maximum value of the number of bits in the product term with the same number of channels compressed through the Wallace tree among all precision types supported by the computing apparatus.

For example, in response to the number of bits of the product term obtained by direct compression being less than the second value, zero-padding is performed on a high bit of the product term to expand the number of bits of the product term to the second value.

For example, in one example, the computing apparatus supports multiply-accumulate computation of a plurality of precision types such as FP16, FP32, BF16, etc., the bit-width of the input and output of the Wallace tree compression process required by FP32 is the largest, e.g., at the first Wallace tree compression, calculation results of 16 channels are required in FP32, each calculation result includes 4 product terms and each product term requires 68 bits, i.e., the second value is 68.

Thus, in the calculation result with 16 channels set up on the hardware circuit of the Wallace tree, the bit-width of the product term is 68 bits, and if other precision types are compressed through the circuitry of the Wallace tree and the bit-width of the product term is less than 68 bits, at least one zero is padded in the high bit to expand the number of bits of the product term to 68 bits.

For example, in a specific example, taking the second level unit used by the FP32 as an example, the input is 32 pairs of partial products, i.e., 32 partial products res_a and 32 partial products res_b, each of the partial products has a bit-width of 64 bits.

The 32 pairs of partial products are padded and truncated to obtain calculation results of 16 channels, each calculation result includes 4 product terms, each product term includes 68 bits, where 4 zeros are added to the high bits of each partial product as a product term.

Afterward, a Wallace tree compression is performed on the calculation results of 16 channels to obtain an intermediate result; afterwards, the intermediate result is padded and truncated to be converted into calculation results of 8 channels, each calculation result includes 4 product terms, each product term is 53 bits, including 2 zeros padded in the high bits; afterwards, another Wallace tree compression is performed on the calculation results of 8 channels to obtain an intermediate result; after that, the intermediate result is truncated and converted to the calculation results of 4 channels; finally, a Wallace tree compression is performed on the calculation results of 4 channels to obtain the final compression result.

For FP16 or BF16, when it performs the Wallace tree compression, if the number of bits of each product term in the 16-channel calculation result is less than 68, zero-padding is performed to expand the number of bits of the product term to 68; similarly, for the 8-channel calculation result, if the number of bits of the product term is less than 53, zero-padding is performed to expand the number of bits to 53.

In this embodiment, the Wallace tree used by the FP32 is selected as the basic data path, and by multiplexing the circuitry of the Wallace tree, the product term whose bit-width does not meet the requirement is expanded by zero-padding to support the compression of other precision, and minimize the consumption of resources on the hardware.

The third level unit receives the compression result from the second level unit, further compresses the compression result and pads zeros into it, and then adds it to the sign compensation value obtained based on the sign compensation flag bit to output a final output result.

For example, in the computing apparatus provided in at least one embodiment of the present disclosure, as illustrated in FIG. 1, the calculation module 102 further includes a NaN processing module 1023. The NaN processing module 1023 is configured to determine whether a NaN (Not A Number) exists in the N pairs of input parameters based on a NaN marker corresponding to each input parameter provided by the preprocessing module 101; and, if a NaN exists, the NaN flag bit is set to a first value (e.g., 1) to directly output the NAN result via the 2-way multiplexer in FIG. 1; if a NaN does not exist, the NaN flag bit is set to a second value (e.g., 0) to output the computation result of the mantissa computing unit via the 2-way multiplexer in FIG. 1.

For example, the NaN processing module 1023 includes a first pathway, a second pathway, and a multiplexer.

For example, the first pathway is configured to receive N pairs of input parameters of the first floating-point type, determine whether a NaN exists in the N pairs of input parameters, and in response to the NaN existing, output the NaN in the N pairs of input parameters.

For example, the second pathway is configured to receive N pairs of input parameters of a second floating-point type, determine whether a NaN exists in the N pairs of input parameters, and in response to the NaN existing, output the NaN in the N pairs of input parameters.

For example, the multiplexer is configured to select an output value of one of the first pathway or the second pathway based on a floating-point type marker.

For example, the first pathway and the second pathway include multiple levels of dual-input multiplexed selection trees, each level of dual-input multiplexed selection tree includes a plurality of dual-input multiplexers.

For example, the first floating-point type includes FP16 or BF16, the data line bit-width is 1024 bits, N is 128, the first pathway includes a 7-level dual-input multiplexed selection tree, the first level dual-input multiplexed selection tree includes 64 dual-input multiplexers, the second level dual-input multiplexed selection tree includes 32 dual-input multiplexers, . . . , the 7th level dual-input multiplexed selection tree includes 1 dual-input multiplexer. By multiple levels of dual-input multiplexed selection trees, the mantissa of 128 input parameters together with the corresponding sign bits are selected one in groups of two by two to propagate to the next level, and finally the NaN in the N pairs of input parameters is output, and if more than one NaN exists, the NaN with the smallest subscript is output.

Because the FP16 and the BF16 multiplex the same NaN processing module, zero-padding may be performed on the lowest three bits of the mantissa of the BF16 to be expanded to 10, so as to use the same first path as the FP16.

For example, the second floating-point type includes FP32, N is 64, the second pathway includes a 6-level dual-input multiplexed selection tree, the first level dual-input multiplexed selection tree includes 32 dual-input multiplexers, the second level dual-input multiplexed selection tree includes 16 dual-input multiplexers, . . . , the 6th level dual-input multiplexed selection tree includes 1 dual-input multiplexer. By multiple levels of dual-input multiplexed selection trees, the mantissa of 64 input parameters together with the corresponding sign bits are selected one in groups of two by two to propagate to the next level, and finally the NaN in the N pairs of input parameters is output, and if more than one NaN exists, the NaN with the smallest subscript is output.

It is to be noted that for the NaN processing module, the parameter used for computation thereof should be the input parameter, and if the processed input parameter is input into the NaN processing module, it is necessary to first restore the processed input parameter to the format of the input parameter before computation.

It is to be noted that in the present disclosure, the first floating-point type is BF16, FP16, and the second floating-point type is FP32 as an example for the description of a specific embodiment, but the present disclosure is not limited thereto, e.g., the first floating-point type may also be other floating-point type satisfying the definition of the first floating-point type, for example, TF32, etc., and similarly, the second floating-point type may also be other floating-point type satisfying the definition of the second floating-point type definition, such as FP64, etc., and the present disclosure is not specifically limited thereto. Other floating-point types may also be realized in a similar manner to the embodiments provided in the present disclosure.

In addition, the computing apparatus provided in at least one embodiment of the present disclosure may support multiply-accumulate computations of conventional integer types in addition to floating-point types, for example, taking a data line bit-width of 1024 bits as an example, the computing apparatus supports 128 pairs of multiply-accumulate computations of type INT8 (8-bit integer), or 64 pairs of multiply-accumulate computations of type INT16 (16-bit integer). For example, the multiply-accumulate computation for an integer type may be completed without preprocessing and without going through the exponent computing unit, and the corresponding multiplication calculation may be completed directly through the mantissa computing unit, which will not be repeated.

The computing apparatus provided in at least one embodiment of the present disclosure is able to support multiply-accumulate computations of multiple precision types, format conversion is first performed on the input parameter through the preprocessing module, and the number of significant bits in the mantissa of the input parameter whose number of significant bits in the mantissa is less than the first value is expanded to the first value, so that mantissas of all the input parameters of the floating-point type whose number of significant bits in the mantissa less than the first value are processed to the same number of bits. Thereby, it is possible to multiplex the multiplication computation of the mantissa, multiplex the related hardware circuit structure, and save the hardware resource; adders, subtractors, and the like in the exponent computing unit are grouped and multiplexed to save the hardware resource; the multiplication unit is modified so that part of the multiplication unit can support mantissa multiplication calculations of different precision types, and circuit structures such as a Booth multiplier can be multiplexed; furthermore, the bit-width of a product term is expanded by zero-padding to multiplex a Wallace tree circuit structure, which further minimizes the hardware resource, makes the computing apparatus support multiply-accumulate computations in a plurality of precision formats at the cost of lower area and power consumption, and improves the performance of an electronic device adopting the computing apparatus, such as the AI accelerator and the like.

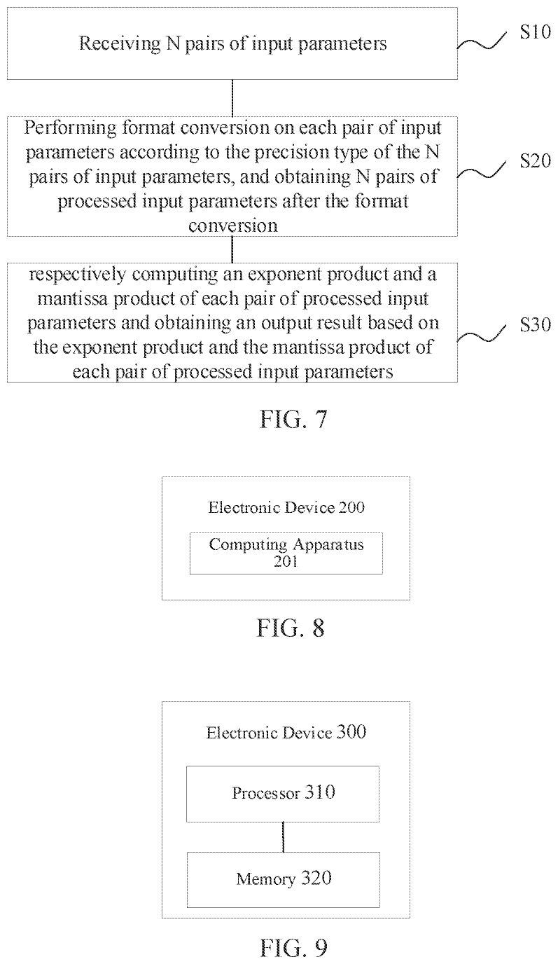

At least one embodiment of the present disclosure further provides a computing method. FIG. 7 is a schematic flowchart of a computing method provided by at least one embodiment of the present disclosure.

As illustrated in FIG. 7, the computing method provided by the at least one embodiment of the present disclosure includes step S10 to step S30.

For example, in step S10, receiving N pairs of input parameters.

For example, each pair of input parameters includes two input parameters, the N pairs of input parameters have a same precision type, and N is a positive integer.

For example, each of the N pairs of input parameters may include two input parameters, and the N pairs of input parameters have the same precision type. For example, the product result corresponding to a pair of input parameters is a product of two input parameters included in the pair of input parameters.

The relevant description of the N pairs of input parameters can be referred to the relevant description of the aforementioned computing apparatus, which will not be repeated.

In step S20, performing format conversion on each pair of input parameters according to the precision type of the N pairs of input parameters, and obtaining N pairs of processed input parameters after converting.

For example, the number of significant bits in the mantissa of the input parameter of the first floating-point type is less than or equal to the first value.

For example, in a process of the format conversion, for each input parameter whose precision type is a first floating-point type, expanding a number of significant bits of a mantissa of the input parameter to a first value, and adding exponent information of the input parameter to the mantissa of the input parameter to obtain a processed input parameter corresponding to the input parameter.

For example, performing format conversion on each pair of input parameters according to the precision type of the N pairs of input parameters may include: for each input parameter, in response to the precision type of the input parameter being the first floating-point type: discarding the lowest m bits of the exponent of the input parameter, m being a positive integer, performing a complementing operation on the mantissa of the input parameter, shifting the complemented mantissa by a value indicated by the m bits to expand the number of significant bits in the mantissa of the input parameter to the first value to obtain a processed input parameter corresponding to the input parameter.

For example, the complementing operation includes complementing a 1 in front of the most significant bit of the mantissa of the input parameter. For example, at least the implicit bit of the mantissa is complemented in the complementing operation, i.e., a 1 is complemented in front of the most significant bit of the mantissa of the input parameter.

Of course, according to the requirement of the number of bits, if the mantissa is not able to be expanded to the first value only by shifting the mantissa after complementing the implicit bit by a value indicated by the m bits, the complementing operation may further include continuing to complement at least one 0 at a higher bit of the implicit bit after complementing the implicit bit until it is able to expand the mantissa to the first value after shifting the complemented mantissa by a value indicated by the m bits.

The specific process of format conversion may be referred to the relevant description of the preprocessing module in the aforementioned computing apparatus, which will not be repeated.

For example, in the above embodiment, the lowest m bits of the exponent of the input parameter are discarded to reduce the bit-width of the exponent and effectively simplify the calculation logic of the exponent; the complemented mantissa is shifted by the value indicated by the m bits in order to add the exponent information of the input parameter to the mantissa of the input parameter, which reduces the effect of the precision of the computation result; and the precision preprocessing for the floating-point can fully multiplex the calculation logic and the hardware resource of the multiplication portion. For each input parameter of the first floating-point type, the above pre-processing can be performed, the mantissas of the processed input parameters have the same number of bits, and the same data processing path can be fully multiplexed. Thereby, it is possible to significantly save the hardware resource, minimize the consumption of the hardware resource, and make the computing apparatus support multiply-accumulate computations in a plurality of precision formats at the cost of lower area and power consumption.

In step S30, respectively computing an exponent product and a mantissa product of each pair of processed input parameters, and obtaining an output result based on the exponent product and the mantissa product of each pair of processed input parameters.

For example, the output result is an accumulated sum of N product results corresponding to N pairs of input parameters one by one.

For example, respectively computing an exponent product and a mantissa product of each pair of processed input parameters, and obtaining an output result based on the exponent product and the mantissa product of each pair of processed input parameters, may include: performing a calculation on exponents of each pair of processed input parameters to obtain an exponent shift value corresponding to each pair of processed input parameters; computing in parallel mantissa products of the N pairs of processed input parameters using a plurality of multiplication units in combination with the exponent shift value corresponding to each pair of processed input parameters, and outputting N sets of intermediate results corresponding to the N pairs of processed input parameters, each set of intermediate results including two partial products and a sign compensation flag bit; performing at least one Wallace tree compression on partial products of the N sets of intermediate results to obtain a compression result; and obtaining the output result using an adder in combination with sign compensation flag bits in the N sets of intermediate results and the compression result.

For example, the exponent shift value indicates a difference between the summing result of exponents of each pair of processed input parameters relative to a maximum exponent value, the maximum exponent value is the maximum value among summing results of exponents of the N pairs of processed input parameters. For example, the exponent shift value is used to shift the mantissa product result so that the exponents of the product results of the N pairs of processed input parameters are the same, i.e., they are all the maximum exponent value, so that the accumulation computation can be performed directly.

For example, performing a calculation on exponents of each pair of processed input parameters to obtain an exponent shift value corresponding to each pair of processed input parameters may include: if the processed input parameter is obtained after performing format conversion on the input parameter of the first floating-point type, computing in parallel sums of exponents of N1 pairs of processed input parameters to obtain N1 exponent computation results, and determining the maximum value of the N1 exponent computation results as a first maximum value, computing in parallel sums of exponents of N2 pairs of processed input parameters to obtain N2 exponent computation results, and determining a maximum value of the N2 exponent computation results as a second maximum value, where N1 and N2 are positive integers and N1+N2 is equal to N; if the processed input parameter is obtained after performing format conversion on the input parameter of the second floating-point type, computing in parallel sums of exponents of the N pairs of processed input parameters to obtain N exponent computation results, and determining the maximum value of the N exponent computation results as a second maximum value; determining a larger value between the first maximum value and the second maximum value as the maximum exponent value; and computing a difference between a computation result of exponents of each pair of processed input parameters relative to the maximum exponent value to obtain the exponent shift value corresponding to each pair of processed input parameters.

The specific process of computing sums of exponents of N1 pairs of processed input parameters can be referred to the relevant description of the first subunit as described above, and will not be repeated herein.

The specific process of computing in parallel sums of exponents of N2 pairs of processed input parameters or sums of exponents of the N pairs of processed input parameters can be referred to the relevant description of the aforementioned second subunit and will not be repeated herein.

The specific process of determining the maximum exponent value and the exponent shift value corresponding to each pair of processed input parameters can be referred to the relevant description of the aforementioned third subunit and will not be repeated herein.

In the above embodiment, the calculation of the exponent can simultaneously support a plurality of precision types such as FP16, BF16, FP32, etc., which minimizes the hardware resource as much as possible and multiplexes more hardware circuit logic.

For example, when performing a multiplication calculation on the mantissa of the processed input parameter corresponding to the input parameter of the first floating-point type, computing in parallel mantissa products of the N pairs of processed input parameters using a plurality of multiplication units in combination with the exponent shift value corresponding to each pair of processed input parameters, and outputting N sets of intermediate results corresponding to the N pairs of processed input parameters, may include: obtaining, with respect to an i-th pair of processed input parameters, L partial products corresponding to the i-th pair of processed input parameters by a Booth multiplier, where L is a positive integer; performing at least one Wallace tree compression on the L partial products to obtain a first intermediate compression result; shifting the first intermediate compression result according to an exponent shift value corresponding to the i-th pair of processed input parameters to obtain two partial products of a set of intermediate results corresponding to the i-th pair of processed input parameters; shifting a sign compensation reference constant based on an exponent shift value corresponding to the i-th pair of processed input parameters to obtain a sign compensation flag bit of the set of intermediate results corresponding to the i-th pair of processed input parameters, where i is a positive integer.

For example, performing multiplication calculation on the mantissa of the processed input parameter corresponding to the input parameter of the first floating-point type may be accomplished by a first multiplication unit or a second multiplication unit, e.g., the first multiplication unit is a 16-bit multiplier as described hereinabove, and the second multiplication unit is a 24-bit multiplier as described hereinabove.

With respect to the multiplication calculation of the mantissa of the processed input parameter corresponding to the input parameter of the first floating-point type, reference may be made to the relevant contents in the aforementioned computing unit, for example, the relevant descriptions in the first multiplication unit or the second multiplication unit, which will not be repeated.

For example, when performing multiplication calculation on the mantissa of the processed input parameters corresponding to the input parameter of the second floating-point type, computing in parallel mantissa products of the N pairs of processed input parameters using a plurality of multiplication units in combination with the exponent shift value corresponding to each pair of processed input parameters, and outputting N sets of intermediate results corresponding to the N pairs of processed input parameters, may include: obtaining, with respect to an i-th pair of processed input parameters, L+O partial products corresponding to the i-th pair of processed input parameters by a Booth multiplier, both L and O being positive integers; performing at least one Wallace tree compression on L partial products to obtain a first intermediate compression result; performing at least one Wallace tree compression on O partial products to obtain a second intermediate compression result; performing at least one Wallace tree compression on the first intermediate compression result and the second intermediate compression result to obtain a third intermediate compression result; shifting the third intermediate compression result according to an exponent shift value corresponding to the i-th pair of processed input parameters to obtain two partial products of a set of intermediate results corresponding to the i-th pair of processed input parameters; shifting a sign compensation reference constant based on an exponent shift value corresponding to the i-th pair of processed input parameters to obtain a sign compensation flag bit of a set of intermediate results corresponding to the i-th pair of processed input parameters, where i is a positive integer.

For example, performing a multiplication calculation on the mantissa of the processed input parameter corresponding to the input parameter of the second floating-point type may be accomplished by a second multiplication unit, for example, the second multiplication unit is the aforementioned 24-bit multiplier.

With respect to the multiplication calculation of the mantissa of the processed input parameter corresponding to the input parameter of the second floating-point type, reference may be made to the relevant contents in the aforementioned computing unit, for example, the relevant descriptions in the second multiplication unit, which will not be repeated.

For example, in the above embodiment, because the number of partial products obtained by multiplying the mantissas of the input parameters of the second floating-point type is much larger, the partial products obtained by the Booth multiplier may be divided into two different channels to be processed separately, the L partial products are processed in the same way as that of the first floating-point type, and the O partial products are processed separately, which can make it possible to multiplex the multiplication unit, multiplex the hardware circuitry as much as possible, and minimize the consumption of hardware resource as much as possible.

For example, performing at least one Wallace tree compression on partial products of the N sets of intermediate results to obtain a compression result may include: further compressing the partial products in the N sets of intermediate results using the Wallace tree and ultimately compressing to two intermediate numbers as the compression result.

For example, during a process of the Wallace tree compression, each Wallace tree compression is performed in a format of a calculation result of at least one channel, the calculation result of each channel including at least one product term.

For example, in the Wallace tree compression process, for each product term in the calculation result with the same number of channels, a number of bits of the product term is a second value, the second value is determined based on the maximum value of the number of bits in the product term with the same number of channels compressed through the Wallace tree among all precision types supported by the computing apparatus.

For example, in response to the number of bits of the product term obtained by direct compression being less than the second value, zero-padding is performed on the high bit of the product term to expand the number of bits of the product term to the second value.

With respect to the specific process of performing at least one Wallace tree compression on partial products of the N sets of intermediate results to obtain a compression result, reference can be made to the relevant description of the aforementioned second level unit, which will not be repeated.

For example, in the above embodiment, the multiplexing of the logic of the Wallace tree is maximized, the precision with the maximum input and output bit-widths when performing Wallace tree compression is selected as the basic data path of the Wallace tree. By multiplexing the circuit of the Wallace tree, it supports compression of other precisions and minimize the hardware resource consumption as much as possible.

For example, obtaining the output result using an adder in combination with sign compensation flag bits in the N sets of intermediate results and the compression result may include: zero-padding and further compressing the compression result, and then adding the compression result with the sign compensation value obtained based on the sign compensation flag bit to obtain the final output result.

With respect to the specific process of obtaining the output result using an adder in combination with sign compensation flag bits in the N sets of intermediate results and the compression result, reference can be made to the relevant description of the aforementioned third level unit, which will not be repeated.

For example, the computing method provided in at least one embodiment of the present disclosure further includes: determining whether a Not a Number (NaN) exists in the input parameters based on a NAN marker for each input parameter.

For example, if a NaN exists, the NaN flag bit is set as a first value (e.g., 1) to directly output the NAN result, and if a NaN does not exist, the NaN flag bit is set as a second value (e.g., 0) to output the output result of the aforementioned computation.

The description related to the NaN judgment can be referred to the description related to the aforementioned NaN processing module, which will not be repeated.

At least one embodiment of the present disclosure provides a computing method provided capable of supporting multiply-accumulate computations of multiple precision types, format conversion is first performed on the input parameter, and the number of significant bits in the mantissa of the input parameter whose number of significant bits in the mantissa is less than the first value is expanded to the first value, so that mantissas of all the input parameters of the floating-point type whose number of significant bits in the mantissa less than the first value are processed to the same number of bits. Thereby, it is possible to multiplex the multiplication computation of the mantissa, multiplex the related hardware circuit structure, and save the hardware resource. Mantissa multiplication calculations of different precision types of can be supported, and circuit structures such as a Booth multiplier can be multiplexed; furthermore, the bit-width of a product term is expanded by zero-padding to multiplex a Wallace tree circuit structure, which further minimizes the hardware resource, makes the computing apparatus support multiply-accumulate computations in a plurality of precision formats at the cost of lower area and power consumption, and improves the performance of an electronic device adopting the computing apparatus, such as the Al accelerator and the like.

Some embodiments of the present disclosure also provide an electronic device. FIG. 8 is a schematic block diagram of an electronic device provided by at least one embodiment of the present disclosure.

As illustrated in FIG. 8, the electronic device 200 includes a computing apparatus 201. e.g., the computing apparatus 201 may be the aforementioned computing apparatus 100, which will not be repeated.

For example, the electronic device may be a processor that is required to perform a multiply-accumulate computation, for example, the electronic device may be a general-purpose processor such as a multi-core processor, a digital signal processor, etc., and the electronic device is capable of performing a multiply-accumulate computation such as matrix multiplication or convolution multiplication operations using the computing apparatus. For example, the electronic device may be a component specifically provided for optimized computation in some AI accelerators, such as a deep learning accelerator. Of course, the present disclosure is not limited to this, and the electronic device may be any device that needs to be loaded with a computing apparatus provided in at least one embodiment of the present disclosure for performing multiply-accumulate computations of the corresponding multiple precision types.

It is noted that in embodiments of the present disclosure, the electronic device 200 may include more or fewer circuits or units, for example, it may also include other circuits or units that support the operation of the computing apparatus 201, to which the present disclosure is not specifically limited.

The connection relationship between the various circuits or units is not limited, and may be based on actual needs. The specific manner of constituting the various circuits or units is not limited, and may be constituted by an analog device according to a circuit principle, or by a digital chip, or in other applicable ways.

Some embodiments of the present disclosure also provide another electronic device. FIG. 9 is a schematic block diagram of another electronic device provided by at least one embodiment of the present disclosure.

For example, as illustrated in FIG. 9, the electronic device 300 includes a processor 310 and a memory 320. it should be noted that the components of the electronic device 300 illustrated in FIG. 9 are exemplary and not limiting, and the electronic device 300 may have other components as needed for practical applications.

For example, the processor 310 and the memory 320 may directly or indirectly communicate with each other.

For example, the processor 310 and the memory 320 may communicate via a network. The network may include a wireless network, a wired network, and/or any combination of a wireless network and a wired network. The processor 310 and the memory 320 may also communicate with each other via a system bus, which is not limited by the present disclosure.

For example, in some embodiments, the memory 320 is used to store computer-readable instructions non-transiently. When the processor 310 is used to run the computer-readable instructions, the computer-readable instructions are run by the processor 310 to implement the computing method according to any of the above-described embodiments. Specific implementations of the various steps of the computing method and related explanatory content can be found in the above-described embodiments of the computing method, which will not be repeated herein.

For example, the processor 310 may control other components in the electronic device 300 to perform desired functions. The processor 310 may be a network processor (NP), a neural network processing unit (NPU), a digital signal processor (DSP), an application specific integrated circuit (ASIC), a field programmable gate array (FPGA), or another programmable logic devices, discrete gate or transistor logic devices, and discrete hardware components.

For example, the memory 320 may include any combination of one or more computer program products, and the computer program products may include various forms of computer-readable storage mediums, such as volatile memory and/or non-volatile memory. The volatile memory may, for example, include random access memory (RAM) and/or cache memory (cache), etc. The non-volatile memory may for example include read-only memory (ROM), hard disk, erasable programmable read-only memory (EPROM), portable compact disk read-only memory (CD-ROM), USB memory, flash memory, etc. One or more computer-readable instructions may be stored on the computer-readable storage medium, and the processor 310 may run the computer-readable instructions to implement various functions of the electronic device 300. Various applications, various data, and the like may also be stored in the storage medium.

For example, in some embodiments, the electronic device 300 may be a mobile phone, a tablet computer, an electronic paper, a television, a monitor, a laptop computer, a digital photo frame, a navigator, a wearable electronic device, a smart home device, and the like.

For example, the electronic device 300 may include a display panel, and the display panel may be used to display interactive content and the like. For example, the display panel may be a rectangular panel, a circular panel, an oval panel, or a polygonal panel, etc. In addition, the display panel may be not only a flat panel, but also a curved panel or even a spherical panel.

For example, the electronic device 300 may have a touch function, i.e., the electronic device 300 may be a touch device.

For example, a detailed description of the process of the electronic device 300 performing the computing method can be referred to the relevant description in the embodiment of the computing method, which will not be repeated.

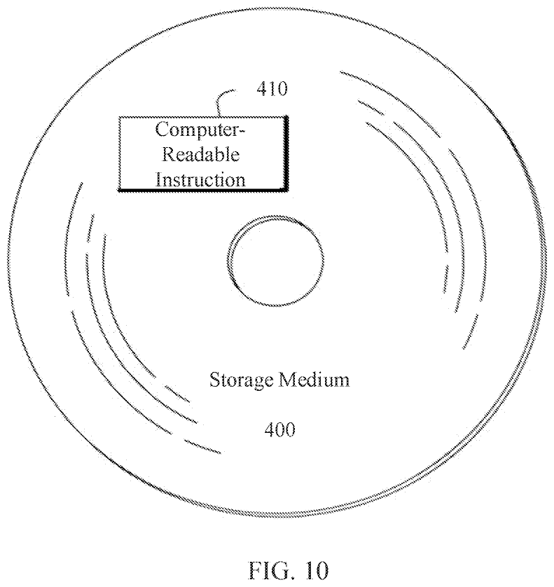

FIG. 10 is a schematic diagram of a non-transient computer-readable storage medium provided by at least one embodiment of the present disclosure. For example, as illustrated in FIG. 10, one or more computer-readable instructions 410 may be stored non-transitory on the storage medium 400. For example, the computer-readable instructions 410, upon being executed by a processor, may perform one or more steps according to the computing method described above.

For example, the storage medium 400 may be applied to the electronic device 300 described above. For example, the storage medium 400 may include a memory 320 in the electronic device 300.

For example, a description of the storage medium 400 may refer to the description of the memory 320 in the embodiment of the electronic device 300, which will not be repeated.

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments of the present disclosure may be implemented in software or hardware. The name of the unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

According to one or more embodiments of the present disclosure, a computing apparatus is provide. The computing apparatus comprises: a preprocessing module, configured to: receive N pairs of input parameters, wherein each pair of input parameters comprises two input parameters, the N pairs of input parameters have a same precision type, and N is a positive integer; and perform format conversion on each pair of input parameters according to the precision type of the N pairs of input parameters, and obtain N pairs of processed input parameters after the format conversion, wherein, in a process of the format conversion, for each input parameter whose precision type is a first floating-point type, expanding a number of significant bits in a mantissa of the input parameter to a first value, and adding exponent information of the input parameter to the mantissa of the input parameter to obtain a processed input parameter corresponding to the input parameter, wherein the number of significant bits in the mantissa of the input parameter of the first floating-point type is less than or equal to the first value; and a calculation module, configured to: respectively compute an exponent product of each pair of processed input parameters and a mantissa product of each pair of processed input parameters, and obtain an output result based on the exponent product and the mantissa product of each pair of processed input parameters, wherein the output result is an accumulated sum of N product results corresponding to the N pairs of input parameters one by one, wherein the computing apparatus supports multiply-accumulate computation of a plurality of floating-point types.

According to one or more embodiments of the present disclosure, wherein the preprocessing module, when performing format conversion on each pair of input parameters according to the precision type of the N pairs of input parameters, the computing apparatus is configured for: for each input parameter, in response to the precision type of the input parameter being the first floating-point type: discarding lowest m bits of an exponent of the input parameter, m being a positive integer, performing a complementing operation on the mantissa of the input parameter, and shifting a complemented mantissa by a value indicated by the m bits to expand the number of significant bits in the mantissa of the input parameter to the first value to obtain a processed input parameter corresponding to the input parameter.

According to one or more embodiments of the present disclosure, wherein the complementing operation comprises complementing a 1 in front of a most significant bit in the mantissa of the input parameter.

According to one or more embodiments of the present disclosure, wherein the calculation module comprises an exponent computing unit and a mantissa computing unit, wherein the exponent computing unit is configured to perform a calculation on exponents of each pair of processed input parameters to obtain an exponent shift value corresponding to each pair of processed input parameters, wherein the exponent shift value indicates a difference between a summing result of the exponents of each pair of processed input parameters relative to a maximum exponent value, the maximum exponent value is a maximum value among summing results of exponents of the N pairs of processed input parameters; the mantissa computing unit is configured to perform a multiplication calculation on mantissas of each pair of processed input parameters in combination with the exponent shift value corresponding to each pair of processed input parameters to obtain the output result, wherein the mantissa computing unit comprises multiplication units of at least two precision types, the multiplication units of at least two precision types comprise a first multiplication unit and a second multiplication unit, the first multiplication unit and the second multiplication unit both supports a multiplication calculation on a mantissa of a processed input parameter corresponding to the input parameter of the first floating-point type, and the second multiplication unit supports a multiplication calculation on a mantissa of a processed input parameter corresponding to an input parameter of a second floating-point type, wherein a number of significant bits in a mantissa of the input parameter of the second floating-point type is greater than the first value.

According to one or more embodiments of the present disclosure, wherein the exponent computing unit comprises a first subunit, a second subunit and an output subunit, the first subunit is configured to: compute sums of exponents of N1 pairs of processed input parameters in parallel, to obtain N1 exponent computation results, wherein the N1 pairs of processed input parameters are obtained by performing format conversion on N1 pairs of input parameters of the first floating-point type; and determine a maximum value of the N1 exponent computation results as a first maximum value; the second subunit is configured to: compute sums of exponents of N2 pairs of processed input parameters in parallel, to obtain N2 exponent computation results, wherein the N2 pairs of processed input parameters are obtained by performing format conversion on N2 pairs of input parameters of the first floating-point type; determine a maximum value of the N2 exponent computation results as a second maximum value, wherein N1 and N2 are positive integers, and N1+N2 is equal to N, or compute sums of exponents of the N pairs of processed input parameters in parallel, to obtain N exponent computation results, wherein the N pairs of processed input parameters are obtained by performing format conversion on N pairs of input parameters of the second floating-point type; determine a maximum value of the N exponent computation results as a second maximum value; the output subunit is configured to: determine a larger value between the first maximum value and the second maximum value as the maximum exponent value; and compute a difference between a summing result of the exponents of each pair of processed input parameters relative to the maximum exponent value to obtain the exponent shift value corresponding to each pair of processed input parameters.

According to one or more embodiments of the present disclosure, wherein a data bit-width processed by the first subunit is determined based on a largest exponent bit-width among exponent bit-width of the processed input parameter corresponding to the input parameter of the first floating-point type; a data bit-width processed by the second subunit is determined based on a largest exponent bit-width among exponent bit-width of the processed input parameter corresponding to the input parameter of the second floating-point type.

According to one or more embodiments of the present disclosure, wherein the mantissa computing unit comprises a first level unit, a second level unit and a third level unit, the first level unit is configured to compute in parallel mantissa products of the N pairs of processed input parameters using a plurality of multiplication units in combination with the exponent shift value corresponding to each pair of processed input parameters, and output N sets of intermediate results corresponding to the N pairs of processed input parameters one by one, wherein each set of intermediate results comprises two partial products and a sign compensation flag bit; the second level unit configured to perform at least one Wallace tree compression on partial products of the N sets of intermediate results to obtain a compression result; and the third level unit configured to obtain the output result using an adder in combination with sign compensation flag bits in the N sets of intermediate results and the compression result.

According to one or more embodiments of the present disclosure, wherein the first multiplication unit, when performing multiplication calculation on the mantissa of the processed input parameter corresponding to the input parameter of the first floating-point type, the computing apparatus is configured for: obtaining, with respect to an i-th pair of processed input parameters, L partial products corresponding to the i-th pair of processed input parameters by a Booth multiplier, wherein L is a positive integer; performing at least one Wallace tree compression on the L partial products to obtain a first intermediate compression result; shifting the first intermediate compression result according to an exponent shift value corresponding to the i-th pair of processed input parameters to obtain two partial products of a set of intermediate results corresponding to the i-th pair of processed input parameters; and shifting a sign compensation reference constant based on an exponent shift value corresponding to the i-th pair of processed input parameters to obtain a sign compensation flag bit of the set of intermediate results corresponding to the i-th pair of processed input parameters, wherein i is a positive integer.

According to one or more embodiments of the present disclosure, wherein the second multiplication unit, when performing multiplication calculation on the mantissa of the processed input parameter corresponding to the input parameter of the second floating-point type, the computing apparatus is configured for: obtaining, with respect to an i-th pair of processed input parameters, L+O partial products corresponding to the i-th pair of processed input parameters by a Booth multiplier, wherein both L and O are positive integers; performing at least one Wallace tree compression on L partial products to obtain a first intermediate compression result; performing at least one Wallace tree compression on O partial products to obtain a second intermediate compression result; performing at least one Wallace tree compression on the first intermediate compression result and the second intermediate compression result to obtain a third intermediate compression result; shifting the third intermediate compression result according to an exponent shift value corresponding to the i-th pair of processed input parameters to obtain two partial products of a set of intermediate results corresponding to the i-th pair of processed input parameters; and shifting a sign compensation reference constant based on an exponent shift value corresponding to the i-th pair of processed input parameters to obtain a sign compensation flag bit of a set of intermediate results corresponding to the i-th pair of processed input parameters, wherein i is a positive integer.

According to one or more embodiments of the present disclosure, wherein the O partial products obtained from the second multiplication unit are transferred to an idle first multiplication unit to perform subsequent Wallace tree compression.

According to one or more embodiments of the present disclosure, wherein in response to the first floating-point type being BF16 or FP16, the sign compensation reference constant is 0xF0, and in response to the second floating-point type being FP32, the sign compensation reference constant is 0x2 aaaa aa00 0000.

According to one or more embodiments of the present disclosure, wherein, during a process of the Wallace tree compression, each Wallace tree compression is performed in a format of a calculation result of at least one channel, a calculation result of each channel comprises at least one product term, for each product term in the calculation result with a same number of channels, a number of bits of the product term is a second value, wherein the second value is determined based on a maximum value of the number of bits in the product term with the same number of channels compressed through the Wallace tree among all precision types supported by the computing apparatus; in response to the number of bits of the product term being less than the second value, zero-padding is performed on a most significant bit of the product term to expand the number of bits of the product term to the second value.

According to one or more embodiments of the present disclosure, wherein the first floating-point type is BF16 or FP16, and the second floating-point type is FP32, the first multiplication unit is a 16-bit multiplier and the second multiplication unit is a 24-bit multiplier.

According to one or more embodiments of the present disclosure, the computing apparatus further comprises a NaN processing module configured to determine whether a NaN exists in the N pairs of input parameters based on a NaN marker corresponding to each input parameter provided by the preprocessing module; wherein the NaN processing module comprises a first pathway, a second pathway and a multiplexer, the first pathway is configured to receive N pairs of input parameters of the first floating-point type, determine whether a NaN exists in the N pairs of input parameters, and in response to the NaN existing, output the NaN in the N pairs of input parameters; the second pathway is configured to receive N pairs of input parameters of a second floating-point type, determine whether a NaN exists in the N pairs of input parameters, and in response to the NaN existing, output the NaN in the N pairs of input parameters, wherein a number of significant bits in a mantissa of an input parameter of the second floating-point type is greater than the first value; the multiplexer is configured to select an output value of one of the first pathway or the second pathway based on a floating-point type marker.

According to one or more embodiments of the present disclosure, a computing method is provided. The computing method comprises: receiving N pairs of input parameters, wherein each pair of input parameters comprises two input parameters, the N pairs of input parameters have a same precision type, and N is a positive integer, performing format conversion on each pair of input parameters according to the precision type of the N pairs of input parameters, and obtaining N pairs of processed input parameters after the format conversion, wherein in a process of the format conversion, for each input parameter whose precision type is a first floating-point type, expanding a number of significant bits in a mantissa of the input parameter to a first value, and adding exponent information of the input parameter to the mantissa of the input parameter to obtain a processed input parameter corresponding to the input parameter, wherein the number of significant bits in the mantissa of the input parameter of the first floating-point type is less than or equal to the first value; and respectively computing an exponent product of each pair of processed input parameters and a mantissa product of each pair of processed input parameters, and obtaining an output result based on the exponent product and the mantissa product of each pair of processed input parameters, wherein the output result is an accumulated sum of N product results corresponding to the N pairs of input parameters one by one.

According to one or more embodiments of the present disclosure, wherein the performing format conversion on each pair of input parameters according to the precision type of the N pairs of input parameters, comprises: for each input parameter, in response to the precision type of the input parameter being the first floating-point type: discarding lowest m bits of an exponent of the input parameter, m being a positive integer, performing a complementing operation on the mantissa of the input parameter, shifting a complemented mantissa by a value indicated by the m bits to expand the number of significant bits in the mantissa of the input parameter to the first value to obtain a processed input parameter corresponding to the input parameter.

According to one or more embodiments of the present disclosure, wherein the respectively computing an exponent product a of each pair of processed input parameters and a mantissa product of each pair of processed input parameters, and obtaining an output result based on the exponent product and the mantissa product of each pair of processed input parameters, comprises: performing a calculation on exponents of each pair of processed input parameters to obtain an exponent shift value corresponding to each pair of processed input parameters, wherein the exponent shift value indicates a difference between a summing result of the exponents of each pair of processed input parameters relative to a maximum exponent value, the maximum exponent value is a maximum value among summing results of exponents of the N pairs of processed input parameters; computing in parallel mantissa products of the N pairs of processed input parameters using a plurality of multiplication units in combination with the exponent shift value corresponding to each pair of processed input parameters, and outputting N sets of intermediate results corresponding to the N pairs of processed input parameters one by one, wherein each set of intermediate results comprises two partial products and a sign compensation flag bit; performing at least one Wallace tree compression on partial products of the N sets of intermediate results to obtain a compression result; obtaining the output result using an adder in combination with sign compensation flag bits in the N sets of intermediate results and the compression result.

According to one or more embodiments of the present disclosure, an electronic device is provided. The electronic device comprises the computing apparatus according to any embodiment of the present disclosure.

According to one or more embodiments of the present disclosure, an electronic device is provided. The electronic device comprises a memory, non-transiently storing computer executable instructions; a processor, configured to run the computer-executable instructions, wherein the computer executable instructions implement a computing method upon being run by the processor, the computing method comprises: receiving N pairs of input parameters, wherein each pair of input parameters comprises two input parameters, the N pairs of input parameters have a same precision type, and N is a positive integer, performing format conversion on each pair of input parameters according to the precision type of the N pairs of input parameters, and obtaining N pairs of processed input parameters after the format conversion, wherein in a process of the format conversion, for each input parameter whose precision type is a first floating-point type, expanding a number of significant bits in a mantissa of the input parameter to a first value, and adding exponent information of the input parameter to the mantissa of the input parameter to obtain a processed input parameter corresponding to the input parameter, wherein the number of significant bits in the mantissa of the input parameter of the first floating-point type is less than or equal to the first value; and computing, respectively, an exponent product of each pair of processed input parameters and a mantissa product of each pair of processed input parameters, and obtaining an output result based on the exponent product and the mantissa product of each pair of processed input parameters, wherein the output result is an accumulated sum of N product results corresponding to the N pairs of input parameters one by one.

According to one or more embodiments of the present disclosure, a non-transitory computer-readable storage medium is provided, wherein the non-transitory computer-readable storage medium stores computer-executable instructions, the computer-executable instructions upon being executed by a processor implement the computing method according to any embodiment of the present disclosure.

The above description is only the preferred embodiment of the present disclosure and the explanation of the applied technical principles. It should be understood by those skilled in the art that the disclosure scope involved in this disclosure is not limited to the technical scheme formed by the specific combination of the above technical features, but also covers other technical schemes formed by any combination of the above technical features or their equivalent features without departing from the above disclosure concept. For example, the above features are replaced with (but not limited to) technical features with similar functions disclosed in this disclosure.

Furthermore, although the operations are depicted in a particular order, this should not be understood as requiring that these operations be performed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the subject matter has been described in language specific to structural features and/or methodological logical acts, it should be understood that the subject matter defined in the appended claims is not necessarily limited to the specific features or acts described above. On the contrary, the specific features and actions described above are only exemplary forms of implementing the claims.

For this disclosure, the following points need to be explained:
(1) The drawings of the embodiment of the present disclosure only relate to the structure related to the embodiment of the present disclosure, and other structures can refer to the general design.
(2) In case of no conflict, the embodiments of the present disclosure and features in the embodiments can be combined with each other to obtain a new embodiment.

The above is only the specific embodiment of this disclosure, but the protection scope of this disclosure is not limited to this, and the protection scope of this disclosure shall be subject to the protection scope of the claims.

1. A computing apparatus, comprising:
a preprocessing module, configured to:
receive N pairs of input parameters, wherein each pair of input parameters comprises two input parameters, the N pairs of input parameters have a same precision type, and N is a positive integer; and
perform format conversion on each pair of input parameters according to the precision type of the N pairs of input parameters, and obtain N pairs of processed input parameters after the format conversion, wherein, in a process of the format conversion, for each input parameter whose precision type is a first floating-point type, expanding a number of significant bits in a mantissa of the input parameter to a first value, and adding exponent information of the input parameter to the mantissa of the input parameter to obtain a processed input parameter corresponding to the input parameter, wherein the number of significant bits in the mantissa of the input parameter of the first floating-point type is less than or equal to the first value; and
a calculation module, configured to:
respectively compute an exponent product of each pair of processed input parameters and a mantissa product of each pair of processed input parameters, and obtain an output result based on the exponent product and the mantissa product of each pair of processed input parameters, wherein the output result is an accumulated sum of N product results corresponding to the N pairs of input parameters one by one,
wherein the computing apparatus supports multiply-accumulate computation of a plurality of floating-point types.

2. The computing apparatus according to claim 1, wherein the preprocessing module, when performing format conversion on each pair of input parameters according to the precision type of the N pairs of input parameters, the computing apparatus is configured for:
for each input parameter, in response to the precision type of the input parameter being the first floating-point type:
discarding lowest m bits of an exponent of the input parameter, m being a positive integer,
performing a complementing operation on the mantissa of the input parameter, and
shifting a complemented mantissa by a value indicated by the m bits to expand the number of significant bits in the mantissa of the input parameter to the first value to obtain a processed input parameter corresponding to the input parameter.

3. The computing apparatus according to claim 2, wherein the complementing operation comprises complementing a 1 in front of a most significant bit in the mantissa of the input parameter.

4. The computing apparatus according to claim 1, wherein the calculation module comprises an exponent computing unit and a mantissa computing unit, wherein
the exponent computing unit is configured to perform a calculation on exponents of each pair of processed input parameters to obtain an exponent shift value corresponding to each pair of processed input parameters, wherein the exponent shift value indicates a difference between a summing result of the exponents of each pair of processed input parameters relative to a maximum exponent value, the maximum exponent value is a maximum value among summing results of exponents of the N pairs of processed input parameters;
the mantissa computing unit is configured to perform a multiplication calculation on mantissas of each pair of processed input parameters in combination with the exponent shift value corresponding to each pair of processed input parameters to obtain the output result,
wherein the mantissa computing unit comprises multiplication units of at least two precision types, the multiplication units of at least two precision types comprise a first multiplication unit and a second multiplication unit, the first multiplication unit and the second multiplication unit both supports a multiplication calculation on a mantissa of a processed input parameter corresponding to the input parameter of the first floating-point type, and the second multiplication unit supports a multiplication calculation on a mantissa of a processed input parameter corresponding to an input parameter of a second floating-point type, wherein a number of significant bits in a mantissa of the input parameter of the second floating-point type is greater than the first value.

5. The computing apparatus according to claim 4, wherein the exponent computing unit comprises a first subunit, a second subunit and an output subunit,
the first subunit is configured to:
compute sums of exponents of N1 pairs of processed input parameters in parallel, to obtain N1 exponent computation results, wherein the N1 pairs of processed input parameters are obtained by performing format conversion on N1 pairs of input parameters of the first floating-point type; and
determine a maximum value of the N1 exponent computation results as a first maximum value;
the second subunit is configured to:
compute sums of exponents of N2 pairs of processed input parameters in parallel, to obtain N2 exponent computation results, wherein the N2 pairs of processed input parameters are obtained by performing format conversion on N2 pairs of input parameters of the first floating-point type;
determine a maximum value of the N2 exponent computation results as a second maximum value, wherein N1 and N2 are positive integers, and N1+N2 is equal to N, or
compute sums of exponents of the N pairs of processed input parameters in parallel, to obtain N exponent computation results, wherein the N pairs of processed input parameters are obtained by performing format conversion on N pairs of input parameters of the second floating-point type; determine a maximum value of the N exponent computation results as a second maximum value;
the output subunit is configured to:
determine a larger value between the first maximum value and the second maximum value as the maximum exponent value; and
compute a difference between a summing result of the exponents of each pair of processed input parameters relative to the maximum exponent value to obtain the exponent shift value corresponding to each pair of processed input parameters.

6. The computing apparatus according to claim 5, wherein a data bit-width processed by the first subunit is determined based on a largest exponent bit-width among exponent bit-width of the processed input parameter corresponding to the input parameter of the first floating-point type;
a data bit-width processed by the second subunit is determined based on a largest exponent bit-width among exponent bit-width of the processed input parameter corresponding to the input parameter of the second floating-point type.

7. The computing apparatus according to claim 4, wherein the mantissa computing unit comprises a first level unit, a second level unit and a third level unit,
the first level unit is configured to compute in parallel mantissa products of the N pairs of processed input parameters using a plurality of multiplication units in combination with the exponent shift value corresponding to each pair of processed input parameters, and output N sets of intermediate results corresponding to the N pairs of processed input parameters one by one, wherein each set of intermediate results comprises two partial products and a sign compensation flag bit;
the second level unit configured to perform at least one Wallace tree compression on partial products of the N sets of intermediate results to obtain a compression result; and
the third level unit configured to obtain the output result using an adder in combination with sign compensation flag bits in the N sets of intermediate results and the compression result.

8. The computing apparatus according to claim 4, wherein the first multiplication unit, when performing multiplication calculation on the mantissa of the processed input parameter corresponding to the input parameter of the first floating-point type, the computing apparatus is configured for:
obtaining, with respect to an i-th pair of processed input parameters, L partial products corresponding to the i-th pair of processed input parameters by a Booth multiplier, wherein L is a positive integer;
performing at least one Wallace tree compression on the L partial products to obtain a first intermediate compression result;
shifting the first intermediate compression result according to an exponent shift value corresponding to the i-th pair of processed input parameters to obtain two partial products of a set of intermediate results corresponding to the i-th pair of processed input parameters; and
shifting a sign compensation reference constant based on an exponent shift value corresponding to the i-th pair of processed input parameters to obtain a sign compensation flag bit of the set of intermediate results corresponding to the i-th pair of processed input parameters,
wherein i is a positive integer.

9. The computing apparatus according to claim 4, wherein the second multiplication unit, when performing multiplication calculation on the mantissa of the processed input parameter corresponding to the input parameter of the second floating-point type, the computing apparatus is configured for:
obtaining, with respect to an i-th pair of processed input parameters, L+O partial products corresponding to the i-th pair of processed input parameters by a Booth multiplier, wherein both L and O are positive integers;
performing at least one Wallace tree compression on L partial products to obtain a first intermediate compression result;
performing at least one Wallace tree compression on O partial products to obtain a second intermediate compression result;
performing at least one Wallace tree compression on the first intermediate compression result and the second intermediate compression result to obtain a third intermediate compression result;
shifting the third intermediate compression result according to an exponent shift value corresponding to the i-th pair of processed input parameters to obtain two partial products of a set of intermediate results corresponding to the i-th pair of processed input parameters; and
shifting a sign compensation reference constant based on an exponent shift value corresponding to the i-th pair of processed input parameters to obtain a sign compensation flag bit of a set of intermediate results corresponding to the i-th pair of processed input parameters,
wherein i is a positive integer.

10. The computing apparatus according to claim 9, wherein the O partial products obtained from the second multiplication unit are transferred to an idle first multiplication unit to perform subsequent Wallace tree compression.

11. The computing apparatus according to claim 8, wherein
in response to the first floating-point type being BF16 or FP16, the sign compensation reference constant is 0xF0, and
in response to the second floating-point type being FP32, the sign compensation reference constant is 0x2 aaaa aa00 0000.

12. The computing apparatus according to claim 7, wherein, during a process of the Wallace tree compression, each Wallace tree compression is performed in a format of a calculation result of at least one channel, a calculation result of each channel comprises at least one product term,
for each product term in the calculation result with a same number of channels, a number of bits of the product term is a second value, wherein the second value is determined based on a maximum value of the number of bits in the product term with the same number of channels compressed through the Wallace tree among all precision types supported by the computing apparatus;
in response to the number of bits of the product term being less than the second value, zero-padding is performed on a most significant bit of the product term to expand the number of bits of the product term to the second value.

13. The computing apparatus according to claim 4, wherein the first floating-point type is BF16 or FP16, and the second floating-point type is FP32,
the first multiplication unit is a 16-bit multiplier and the second multiplication unit is a 24-bit multiplier.

14. The computing apparatus according to claim 1, further comprising a NaN processing module configured to determine whether a NaN exists in the N pairs of input parameters based on a NaN marker corresponding to each input parameter provided by the preprocessing module;
wherein the NaN processing module comprises a first pathway, a second pathway and a multiplexer,
the first pathway is configured to receive N pairs of input parameters of the first floating-point type, determine whether a NaN exists in the N pairs of input parameters, and in response to the NaN existing, output the NaN in the N pairs of input parameters;
the second pathway is configured to receive N pairs of input parameters of a second floating-point type, determine whether a NaN exists in the N pairs of input parameters, and in response to the NaN existing, output the NaN in the N pairs of input parameters, wherein a number of significant bits in a mantissa of an input parameter of the second floating-point type is greater than the first value;
the multiplexer is configured to select an output value of one of the first pathway or the second pathway based on a floating-point type marker.

15. A computing method, comprising:
receiving N pairs of input parameters, wherein each pair of input parameters comprises two input parameters, the N pairs of input parameters have a same precision type, and N is a positive integer,
performing format conversion on each pair of input parameters according to the precision type of the N pairs of input parameters, and obtaining N pairs of processed input parameters after the format conversion, wherein in a process of the format conversion, for each input parameter whose precision type is a first floating-point type, expanding a number of significant bits in a mantissa of the input parameter to a first value, and adding exponent information of the input parameter to the mantissa of the input parameter to obtain a processed input parameter corresponding to the input parameter, wherein the number of significant bits in the mantissa of the input parameter of the first floating-point type is less than or equal to the first value; and
respectively computing an exponent product of each pair of processed input parameters and a mantissa product of each pair of processed input parameters, and obtaining an output result based on the exponent product and the mantissa product of each pair of processed input parameters, wherein the output result is an accumulated sum of N product results corresponding to the N pairs of input parameters one by one.

16. The computing method according to claim 15, wherein the performing format conversion on each pair of input parameters according to the precision type of the N pairs of input parameters, comprises:
for each input parameter, in response to the precision type of the input parameter being the first floating-point type:
discarding lowest m bits of an exponent of the input parameter, m being a positive integer,
performing a complementing operation on the mantissa of the input parameter,
shifting a complemented mantissa by a value indicated by the m bits to expand the number of significant bits in the mantissa of the input parameter to the first value to obtain a processed input parameter corresponding to the input parameter.

17. The computing method according to claim 15, wherein the respectively computing an exponent product a of each pair of processed input parameters and a mantissa product of each pair of processed input parameters, and obtaining an output result based on the exponent product and the mantissa product of each pair of processed input parameters, comprises:
performing a calculation on exponents of each pair of processed input parameters to obtain an exponent shift value corresponding to each pair of processed input parameters, wherein the exponent shift value indicates a difference between a summing result of the exponents of each pair of processed input parameters relative to a maximum exponent value, the maximum exponent value is a maximum value among summing results of exponents of the N pairs of processed input parameters;
computing in parallel mantissa products of the N pairs of processed input parameters using a plurality of multiplication units in combination with the exponent shift value corresponding to each pair of processed input parameters, and outputting N sets of intermediate results corresponding to the N pairs of processed input parameters one by one, wherein each set of intermediate results comprises two partial products and a sign compensation flag bit;
performing at least one Wallace tree compression on partial products of the N sets of intermediate results to obtain a compression result;
obtaining the output result using an adder in combination with sign compensation flag bits in the N sets of intermediate results and the compression result.

18. An electronic device, comprising the computing apparatus according to claim 1.

19. An electronic device comprising:
a memory, non-transiently storing computer executable instructions;
a processor, configured to run the computer-executable instructions,
wherein the computer executable instructions implement a computing method upon being run by the processor, the computing method comprises:
receiving N pairs of input parameters, wherein each pair of input parameters comprises two input parameters, the N pairs of input parameters have a same precision type, and N is a positive integer,
performing format conversion on each pair of input parameters according to the precision type of the N pairs of input parameters, and obtaining N pairs of processed input parameters after the format conversion, wherein in a process of the format conversion, for each input parameter whose precision type is a first floating-point type, expanding a number of significant bits in a mantissa of the input parameter to a first value, and adding exponent information of the input parameter to the mantissa of the input parameter to obtain a processed input parameter corresponding to the input parameter, wherein the number of significant bits in the mantissa of the input parameter of the first floating-point type is less than or equal to the first value; and
computing, respectively, an exponent product of each pair of processed input parameters and a mantissa product of each pair of processed input parameters, and obtaining an output result based on the exponent product and the mantissa product of each pair of processed input parameters, wherein the output result is an accumulated sum of N product results corresponding to the N pairs of input parameters one by one.

20. A non-transitory computer-readable storage medium, wherein the non-transitory computer-readable storage medium stores computer-executable instructions, the computer-executable instructions upon being executed by a processor implement the computing method according to claim 15.
